(19) United States
(12) Patent Application Publication
(10) Pub. No.: US 2024/0331150 A1
(43) Pub. Date: Oct. 3, 2024

(54) METHOD AND SYSTEM OF PREDICTING PREGNANCY OUTCOMES AND QUALITY GRADES IN MAMMALIAN EMBRYOS

(71) Applicant: VYTELLE LLC, Lenexa, KS (US)

(72) Inventors: Tasha Gruhot, Hawarden, IA (US); Bruno Valente Sanches, Southlake, TX (US)

(21) Appl. No.: 18/620,639

(22) Filed: Mar. 28, 2024

Related U.S. Application Data
(60) Provisional application No. 63/492,879, filed on Mar. 29, 2023.

(51) Int. Cl. G06T 7/00; G06T 3/40; G06T 7/12; G06T 7/13

(52) U.S. Cl. CPC G06T 7/0012; G06T 3/40; G06T 7/12; G06T 7/13; G06T 2207/10024; G06T 2207/10056; G06T 2207/20081; G06T 2207/20084; G06T 2207/30044

(57) ABSTRACT

A method and system for predicting embryo grade, stage and/or pregnancy outcome in a mammalian embryo, which includes observing a plurality of mammalian embryos with a microscope, observing a plurality of digital images of mammalian embryos with a camera, converting the plurality of digital images of mammalian embryo from RGB to greyscale, detecting, diluting, and expanding the boundaries of the mammalian embryo followed by segmenting, cropping and isolating the digital images or utilizing the plurality of digital images of mammalian embryos that are both original images and mask images with a convolutional neural network that minimizes pixel classification errors that provide semantic representations to provide information about embryo qualities with a processor electrically connected to the camera to predict embryo grade, stage and/or pregnancy status of the plurality of mammalian embryos utilizing either a deep neural network segmenter, an autoencoder for extracting features, or a deep neural network.

### CROSS REFERENCE TO RELATED APPLICATIONS

This application claims priority under 35 U.S.C. § 119 to provisional patent application U.S. Ser. No. 63/492,879 filed Mar. 29, 2023. The provisional patent application is herein incorporated by reference in their entirety, including without limitation, the specification, claims, and abstract, as well as any figures, tables, appendices, or drawings thereof.

### FIELD OF THE INVENTION

The present invention generally relates to a system and method for predicting pregnancy outcomes, quality grades and developmental stage in mammalian embryos.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Embryologists currently visually inspect mammalian embryos and assign a grade indicating their quality and a stage indicating their development. Grade 1 mammalian embryos are more likely to produce a pregnancy than grade 2 or grade 3 mammalian embryos. The most common transferable and/or freezable embryos range from developmental stage 4 through 7, with stage 4 being the least mature and still considered a Morula, while stage 7 is more mature as an expanded Blastocyst. Grading is a subjective measure of the embryologist, who determines if the mammalian embryo is of high enough quality to be implanted. A mammalian embryo can visually appear to have the ability to implant and thrive, but still, fail to achieve a mammalian pregnancy. Therefore, evaluating mammalian embryos in a more objective and standardized way would be extremely helpful. This evaluation includes identifying those embryos with a higher likelihood of pregnancy and adding consistency in grading between labs and technicians. This procedure can be implemented to increase the consistency of the mammalian embryos recommended for implantation and freezing and improve the overall pregnancy rate. It would be very desirable to identify mammalian embryos with a higher likelihood of resulting in pregnancy while screening out mammalian embryos that are less likely to result in pregnancy.

Thus, there exists a need in the art for a system and method for predicting pregnancy outcomes in mammalian embryos with a less subjective method of embryo grade and stage classification.

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “camera” refers to an imaging device and may include still cameras, video cameras, cameras utilizing various wavelengths of light as input, and electronic image sensors.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 shows a perspective view of a microscope and video camera setup with a processor in electronic communication with the video camera.

FIG. 2 shows a photographic image of an embryo taken with the system of FIG. 1.

FIG. 3 is a flowchart of an image processing segmentation strategy.

FIG. 4 is a collection of an original mask (segmented), masked images, and cropped images of mammalian embryos.

FIG. 5 is a U-Net deep neural network architecture for embryo image segmentation.

FIG. 6 shows two pairs of original and segmented mammalian embryo images.

FIG. 7 shows a flowchart of the U-Net deep neural network architecture for embryo image segmentation of FIG. 5.

FIG. 8 shows accuracy, recall, precision, and specificity of a ridge regression classifier.

FIG. 9 shows a ROC curve of a ridge regression classifier of FIG. 8.

FIG. 10 shows a confusion matrix for the ridge regression classifier of FIG. 8,

FIG. 11 shows a flow chart of a first strategy utilizing a U-Net feature extractor with a ridge regression classifier.

FIG. 12 shows a second strategy of using an autoencoder with a random forest classifier.

FIG. 13 shows original and reconstructed mammalian embryo images generated with an autoencoder.

FIG. 14 shows accuracy, recall, precision, and specificity involving a random forest classifier trained to predict mammalian embryo pregnancy status or determine mammalian embryo grade from the output of an autoencoder.

FIG. 15 shows a confusion matrix of FIG. 14 of a random forest classifier trained to predict mammalian embryo pregnancy status or determine mammalian embryo grade from the output of an autoencoder.

FIG. 16 shows a flow chart of the second strategy involving an autoencoder that provides input to a random forest classifier.

FIG. 17 shows a third strategy of using a VGG16 deep neural network.

FIG. 18 shows accuracy, recall, and precision of involving a VGG16 deep neural network to predict embryo pregnancy status or determine mammalian embryo grade and stage.

FIG. 19 shows a confusion matrix of FIG. 17 of a VGG16 deep neural network to predict mammalian embryo pregnancy status or determine mammalian embryo grade and stage.

FIG. 20 shows the flow chart of a third strategy involving utilizing a VGG16 deep neural network to predict mammalian embryo pregnancy status or determine mammalian embryo grade and stage.

FIG. 21 shows the deep neural network architecture of ResNet 18 of a fourth strategy to predict mammalian embryo pregnancy status or determine mammalian embryo grade and stage.

FIG. 22 shows the flow chat of embryo classification using ResNet 18 deep neural network to predict mammalian embryo pregnancy status or determine mammalian embryo grade and stage.

FIG. 23 shows the layered deep neural network architecture ResNet 18 for embryo stage prediction. Stage prediction is separated into 2 phases. Phase I classifies the embryo as stage (4 or 5) or as stage (6 or 7) resulting in a binary result. Phase II is used within each binary embryo stage prediction to then classify if the embryo is stage 4 or 5, or 6 or 7. This results in one stage classification per embryo.

FIG. 24 shows the confusion matrix and accuracy of stage classification prediction using Per Frame results from 4,764 embryo images from 96 embryos. Using Per Frame Results for embryo stage resulted in a 84.76% accuracy of Phase I, predicting if an embryo frame is either stage 4 or 5, or stage 6 or 7.

FIG. 25 shows the confusion matrix and accuracy of stage classification prediction using Per Frame results from 4,764 embryo images from 96 embryos. Using Per Frame Results for embryo stage resulted in a 66.55% accuracy of Phase II prediction either stage 4 or 5 and 71.04% accuracy of Phase II predicting either stage 6 or 7.

FIG. 26 shows the confusion matrix and accuracy of stage classification prediction using Majority Voting schema based on per frame classification per embryo (multiple frames per embryo). 96 embryos were classified using 4,764 embryo images. Using Majority Voting Per Frame Results for embryo stage resulted in a 85.42% accuracy of Phase I, predicting an embryo is either stage 4 or 5, or stage 6 or 7.

FIG. 27 shows the confusion matrix and accuracy of stage classification prediction using majority voting schema based on per frame classification per embryo (multiple frames per embryo). 96 embryos were classified using 4,764 embryo images. Using Per Frame Results for embryo stage resulted in a 69.7% accuracy of Phase II prediction either stage 4 or 5 and 73.01% accuracy of Phase II predicting either stage 6 or 7.

FIG. 28 shows the confusion matrix and accuracy of grade classification prediction using Per Frame results from 10,764 embryo images from 467 embryos. Using Per Frame Results for embryo grade resulted in a 76.54% accuracy of predicting Grade 1, Grade 2, or Grade 3 embryos.

FIG. 29 shows the confusion matrix and accuracy of grade classification prediction using majority voting schema based on per frame classification per embryo (Multiple frames per embryo). 467 embryos were classified using 10,764 embryo images. Using Majority Voting Per Frame Results for embryo Grade resulted in a 64.46% accuracy of predication.

FIG. 30 shows the confusion matrix and accuracy of pregnancy prediction using Per Frame results from 4,764 embryo images from 96 embryos. Using Per Frame Results for embryo pregnancy resulted in a 50.6% accuracy of predicting pregnancy via embryo images.

FIG. 31 shows the confusion matrix and accuracy of pregnancy prediction using majority voting schema based on per frame classification per embryo (Multiple frames per embryo). 96 embryos were classified using 4,764 embryo images. Using majority voting from per frame results for embryo pregnancy resulted in a 66.0% accuracy of predicting pregnancy via images of the embryo.

FIG. 32 shows a perspective view of a microscope and hyperspectral video camera setup with a processor in electronic communication with the video camera.

FIG. 33 illustrates pixel intensity across the 8 spectral channels where the variation in the spectral signatures can be visualized individually.

FIG. 34 illustrates pixel intensity across the different spectral channels after all 8 bands are normalized, a process used to allow for comparison of spectral data across different images. The Embryo regions were selected and cropped.

FIG. 35 is an example table of histograms from the 8 band NIR hyperspectral processing/analysis that characterize the pixel intensities of each channel.

FIG. 36 (A&B) illustrates clustering and feature extraction from embryo images taken with the 8 band NIR hyperspectral camera. Different clusters are represented with varying colors used to identify distinct regions within the image. Centroids are defined (FIG. 36A) and plotted for points of interest within the image (FIG. 36B).

FIG. 37 illustrates examples of PCA analysis from selected spectral data as described in FIG. 36.

FIG. 38 illustrates an example of spectral indices that are computed from the images using machine learning models on the 8 band NIR hyperspectral embryo images.

FIG. 39 shows accuracy, recall, and precision and F1-score of involving a random forest machine learning network to predict mammalian embryo grade and stage from 8 band NIR hyperspectral embryo images.

An artisan of ordinary skill in the art need not view, within isolated figure(s), the nearly infinite number of distinct permutations of features described in the following detailed description to facilitate an understanding of the present invention.

### SUMMARY OF THE INVENTION

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

An aspect of the present invention is a system for predicting a pregnancy outcome in a mammalian embryo and/or determining a mammalian embryo grade and stage is disclosed. This system includes a microscope for observing a plurality of mammalian embryos, a video camera mounted to the microscope for obtaining a plurality of digital images of mammalian embryos, and a processor electrically connected to the video camera for receiving the plurality of digital images of mammalian embryos, wherein the plurality of digital images of mammalian embryos are converted from RGB to greyscale, then the boundaries of the mammalian embryos in the plurality of digital images are detected, dilated and expanded, which is then followed by the plurality of digital images of mammalian embryos being segmented, cropped and isolated for utilization in pregnancy prediction and grade/stage classification.

Another aspect of the present invention is that the boundaries of the mammalian embryos in the plurality of digital images are detected and expanded with a Sobel filter and convolutional process utilizing the processor with the plurality of digital images of mammalian embryos being transformed into a symmetric linear structuring element for dilation.

Still another aspect of the present invention is the suppression of light structures connected to the boundaries of the mammalian embryo in the plurality of digital images of mammalian embryos with the processor prior to the plurality of digital images of a mammalian embryo being automatically segmented, cropped, and isolated.

Still yet another aspect of the present invention is the erosion of the pixels from the boundaries of the mammalian embryos in the plurality of digital images with the processor after the suppression of the light structures connected to the boundaries of the mammalian embryos in the plurality of digital images.

Yet another aspect of the present invention is a deep neural network segmenter trained on the segmented, cropped, and isolated plurality of digital images of mammalian embryos for predicting mammalian embryo pregnancy status with a deep neural network image classification with the processor.

In another aspect of the present invention, a deep neural network segmenter is trained on the plurality of segmented, cropped, and isolated digital images of mammalian embryos for determining mammalian embryo pregnancy status with ridge regression models with the deep neural network segmenter's feature maps being utilized for predicting mammalian embryo pregnancy status or mammalian embryo grade and stage with the processor.

In yet another aspect of the present invention, a deep neural network segmenter is trained on the plurality of segmented, cropped, and isolated digital images of mammalian embryos for determining mammalian embryo pregnancy status and grade/stage classification, which is performed on a U-Net with 512 features with a ridge regression model that utilizes a λ of 2.

In yet another aspect of the present invention, a layered deep neural network trained on the plurality of segmented, cropped, and isolated digital images of mammalian embryos for determining mammalian embryo pregnancy status and grade/stage classification, which is performed using ResNet 18 model architecture.

In still yet another aspect of the present invention is an autoencoder for extracting features from the plurality of digital images of mammalian embryos for determining mammalian embryo pregnancy status or mammalian embryo grade and stage with the processor.

In another aspect of the present invention, extracted features are processed with a random forest classifier for determining mammalian embryo pregnancy status or mammalian embryo grade and stage with the processor.

Still another aspect of the present invention is a deep neural network for determining mammalian embryo pregnancy status or mammalian embryo grade and stage with the processor.

In an additional aspect of the present invention, a deep neural network is a VGG16 network.

In another aspect of the present invention, a system for predicting a pregnancy outcome in a mammalian embryo or determining mammalian embryo grade and stage is disclosed. The system includes a microscope for observing mammalian embryos, a video camera mounted to the microscope for obtaining a plurality of digital images of mammalian embryos, and a processor electrically connected to the video camera for receiving the plurality of digital images of mammalian embryos, wherein the plurality of digital images of mammalian embryos are a plurality of both original images and a plurality of mask images with a convolutional neural network that minimizes pixel classification errors and provides semantic representations of the embryos to provide information about embryo qualities that can predict pregnancy status or determine mammalian embryo grade and stage.

Yet another aspect of the present invention includes a convolutional neural network with a trained U-net where 512 features are extracted from the twelfth layer to provide information about embryo qualities that can predict pregnancy status or determine mammalian embryo grade and stage.

In still yet another aspect of the present invention, there is an autoencoder for extracting features from the plurality of digital images of mammalian embryos for determining mammalian embryo pregnancy status or determining mammalian embryo grade and stage with the processor.

In yet another aspect of the present invention, extracted features are processed with a random forest classifier for determining mammalian embryo pregnancy status or determining mammalian embryo grade and stage with the processor.

In yet another aspect of the present invention, a deep neural network like a VGG16 network is utilized.

In yet another aspect of the present invention, a layered deep neural network like a ResNet is utilized.

In yet another aspect of the present invention, post deep neural network image classification, majority voting to assign final classification prediction (pregnancy, grade or stage) is utilized.

In still another aspect of the present invention, a method for predicting a pregnancy outcome in a mammalian embryo or determining mammalian embryo grade and stage is disclosed. The method includes observing a plurality of mammalian embryos with a microscope, recording the plurality of digital images of mammalian embryos with a video camera connected to the microscope, converting the plurality of digital images of mammalian embryos from RGB to greyscale with a processor connected to the video camera, detecting the boundaries of the mammalian embryo in the plurality of digital images with the processor, dilating the boundaries of the mammalian embryo in the plurality of digital images with the processor, expanding the boundaries of the mammalian embryo in the plurality of digital images with the processor, segmenting the plurality of digital images of mammalian embryos with the processor, cropping the plurality of digital images of mammalian embryos with the processor, and isolating the plurality of digital images of mammalian embryos with the processor.

Another aspect of the present invention includes the steps of suppressing light structures connected to the boundaries of the mammalian embryo in the plurality of digital images of mammalian embryos with the processor prior to the segmenting, cropping, and isolating the plurality of digital images of mammalian embryos, and eroding pixels from the boundaries of the mammalian embryos in the plurality of digital images with the processor after the suppression of the light structures connected to the boundaries of the mammalian embryo in the plurality of digital images.

Still, yet another aspect of the present invention includes utilizing a deep neural network segmenter trained on the segmented, cropped, and isolated plurality of digital images of mammalian embryos selected from the group consisting of a deep neural network image classification or ridge regression models with the processor.

In yet another aspect of the present invention, a deep neural network segmenter is trained on the plurality of segmented, cropped, and isolated digital images of mammalian embryos for determining mammalian embryo pregnancy status and grade/stage classification, which is performed using ResNet 18 model architecture implemented in PyTorch using Batchnormalization, Maxpool, and Dropout layers (convolution and identity blocks).

In another aspect of the present invention, a method for predicting a pregnancy outcome in a mammalian embryo or determining a mammalian embryo grade and stage is disclosed. The method includes observing a plurality of mammalian embryos with a microscope, recording a plurality of digital images of mammalian embryos with a video camera that is connected to the microscope, and utilizing the plurality of digital images of mammalian embryos that are a plurality of both original images and a plurality of mask images with a convolutional neural network that minimizes pixel classification errors that provides semantic representations of the embryos to provide information about embryo qualities with a processor that is electrically connected to the video camera to predict pregnancy status or embryo grade of the plurality of mammalian embryos.

In still yet another aspect of the present invention includes predicting a pregnancy outcome or determining mammalian embryo grade in mammalian embryos with a methodology selected from a group consisting of a deep neural network segmenter with U-Net, an autoencoder for extracting features from the plurality of digital images of mammalian embryos with a random forest classifier, or a deep neural network with a VGG16 network with the processor.

An aspect of the present invention is a system for predicting a pregnancy outcome in a mammalian embryo and/or determining a mammalian embryo grade and stage is disclosed. This system includes a microscope for observing a plurality of mammalian embryos, a multiband spectral video camera mounted to the microscope for obtaining a plurality of multiband spectral images of mammalian embryos, and a processor electrically connected to the video camera for receiving the plurality of multiband spectral images of mammalian embryos, images are visualized using the “jet” colormap and pixel intensity across the 8 channels of the NIR multispectral camera per embryo image are analyzed. Images are reshapped into a uniform size and pixel values are normalized to a 0-1 range. Differences/similarities in embryo spectral image regional composition across all 8 bands are identified and clustered. Centroids represent the center of the clusters and function as a learned feature from the machine learning model. Spectral indices are developed via machine learning models which provide quantitative measures/features that are indicative of specific physical/biological properties or composition. The derived features from the spectral images along with any metadata on the embryo is analyzed via machine learning models. These machine learning models classify the embryos based on the extracted features, in this case classifying them for mammalian embryo stage, grade and/or pregnancy status. Models are then evaluated using cross-validations techniques to assess their performance accuracy.

Another aspect of the present invention utilizes selected features from the spectral image data that are analyzed with the following machine learning models but are not limited to only these models: random forest classifiers and multilayer perceptrons. These models classify the embryos based on selected features from the 8 band spectral data and classify the mammalian embryos based on grade, stage, and/or pregnancy status.

In yet another aspect of the present invention, cross validation techniques are utilized following spectral image-based feature selection for machine learning models to predict mammalian embryo grade, stage or pregnancy status may utilize Leave-One-Out Cross-Validation (LOOCV).

In another aspect of the present invention principle component analysis can be utilized to reduce the dimensionality of the spectral data and enable visualization to highlight patterns within the data.

In yet another aspect of the present invention, a method for predicting a pregnancy outcome in a mammalian embryo or determining a mammalian embryo grade and stage is disclosed. The method includes observing singular or plurality of mammalian embryos with a microscope, recording spectral images of mammalian embryos with a multispectral video camera that is connected to the microscope, and utilizing single or plurality of multiband spectral images of mammalian embryos that are a plurality of both original images and a plurality of mask images with machine learning models identify features of selection based on pixel intensity that provides semantic representations of the embryos to provide information about embryo qualities with a processor that is electrically connected to the video camera to predict pregnancy status or embryo grade of the plurality of mammalian embryos.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### EMBODIMENTS

Various embodiments of the systems and methods provided herein are included in the following non-limiting list of embodiments.

1. A system for predicting a pregnancy outcome in a mammalian embryo, which system comprises:
(a) a microscope for observing a plurality of mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are converted from RGB to greyscale, then the boundaries of the mammalian embryos in the plurality of digital images are detected, which is then followed by the plurality of digital images of mammalian embryos being isolated for utilization in pregnancy prediction.
   2. The system for predicting a pregnancy outcome in a mammalian embryo, according to embodiment 1, wherein the boundaries of the mammalian embryos in the plurality of digital images are detected with a Sobel filter and convolutional process utilizing the processor with the plurality of digital images of mammalian embryos being transformed into a symmetric linear structuring element for dilation.
   3. The system for predicting a pregnancy outcome in a mammalian embryo, according to embodiment 1, further comprising suppression of light structures connected to the boundaries of the mammalian embryo in the plurality of digital images of mammalian embryos with the processor prior to the plurality of digital images of mammalian embryo being isolated.
   4. The system for predicting a pregnancy outcome in a mammalian embryo, according to embodiment 3, further comprising erosion of the pixels from the boundaries of the mammalian embryos in the plurality of digital images with the processor after the suppression of the light structures connected to the boundaries of the mammalian embryos in the plurality of digital images.
   5. The system for predicting a pregnancy outcome in a mammalian embryo, according to embodiment 1, further comprising a deep neural network segmenter trained on the isolated plurality of digital images of mammalian embryos for predicting mammalian embryo pregnancy status with a deep neural network image classification with the processor.
   6. The system for predicting a pregnancy outcome in a mammalian embryo, according to embodiment 1, further comprising a deep neural network segmenter trained on the plurality of isolated digital images of mammalian embryos for determining mammalian embryo pregnancy status with ridge regression models with the deep neural network segmenter's feature maps for predicting mammalian embryo pregnancy status with the processor.
   7. The system for predicting a pregnancy outcome in a mammalian embryo, according to embodiment 1, wherein the deep neural network segmenter trained on the plurality isolated digital images of mammalian embryos for determining mammalian embryo pregnancy status is performed on a U-Net with 512 features and a ridge regression model that utilizes a λ of 2.
   8. The system for predicting a pregnancy outcome in a mammalian embryo, according to embodiment 1, wherein the deep neural network segmenter trained on the plurality of isolated digital images of mammalian embryos for determining mammalian embryo pregnancy status is performed using ResNet 18.
   9. The system for predicting a pregnancy outcome in a mammalian embryo, according to embodiment 1, further comprising an autoencoder for extracting features from the plurality of digital images of mammalian embryos for determining mammalian embryo pregnancy status with the processor.
   10. The system for predicting a pregnancy outcome in a mammalian embryo, according to embodiment 9, wherein the extracted features are processed with a random forest classifier for determining mammalian embryo pregnancy status with the processor.
   11. The system for predicting a pregnancy outcome in a mammalian embryo, according to embodiment 1, further comprising a deep neural network for determining mammalian embryo pregnancy status with the processor.
   12. The system for predicting a pregnancy outcome in a mammalian embryo, according to embodiment 11, wherein the deep neural network is a VGG16 network.
   13. The system for predicting a pregnancy outcome in a mammalian embryo, according to embodiment 11, wherein the deep neural network utilizes ResNet 18.
   14. A system for predicting pregnancy outcome in a mammalian embryo, which system comprises:
(a) a microscope for observing mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are a plurality of both original images and a plurality of mask images with a neural network that minimizes pixel classification errors and provides semantic representations of the embryos to provide information about embryo qualities that can predict pregnancy status.
   15. The system for predicting a pregnancy outcome in a mammalian embryo, according to embodiment 14, wherein the neural network includes a trained U-net where 512 features are extracted from the twelfth layer to provide information about embryo qualities that can predict pregnancy status.
   16. The system for predicting a pregnancy outcome in a mammalian embryo, according to embodiment 14, wherein the neural network includes a trained ResNet model that can predict a pregnancy status.
   17. The system for predicting a pregnancy outcome in a mammalian embryo, according to embodiment 14, further comprising an autoencoder for extracting features from the plurality of digital images of mammalian embryos for determining mammalian embryo pregnancy status with the processor.
   18. The system for predicting a pregnancy outcome in a mammalian embryo, according to embodiment 17, wherein the extracted features are processed with a random forest classifier for determining mammalian embryo a pregnancy status with the processor.
   19. The system for predicting a pregnancy outcome in a mammalian embryo, according to embodiment 14, further comprising a deep neural network for determining mammalian embryo a pregnancy status with the processor.
   20. The system for predicting a pregnancy outcome in a mammalian embryo, according to embodiment 19, wherein the deep neural network is a VGG16 network.
   21. The system for predicting a pregnancy outcome in a mammalian embryo, according to embodiment 19, wherein the deep neural network is a ResNet18 structure.
   22. A method for predicting a pregnancy outcome in a mammalian embryo, which method comprises of:
(a) observing a plurality of mammalian embryos with a microscope;
(b) recording the plurality of digital images of mammalian embryos with a camera connected to the microscope;
(c) converting the plurality of digital images of mammalian embryos from RGB to greyscale with a processor connected to the camera;
(d) detecting the boundaries of the mammalian embryo in the plurality of digital images with the processor;
(e) dilating the boundaries of the mammalian embryo in the plurality of digital images with the processor;
(f) expanding the boundaries of the mammalian embryo in the plurality of digital images with the processor;
(g) segmenting the plurality of digital images of mammalian embryos with the processor;
(h) cropping the plurality of digital images of mammalian embryos with the processor; and
(i) isolating the plurality of digital images of mammalian embryos with the processor.
   23. The method for predicting a pregnancy outcome in a mammalian embryo, according to embodiment 22, further comprising:
(a) suppressing light structures connected to the boundaries of the mammalian embryo in the plurality of digital images of mammalian embryos with the processor prior to the segmenting, cropping, and isolating the plurality of digital images of mammalian embryos; and;
(b) eroding pixels from the boundaries of the mammalian embryos in the plurality of digital images with the processor after the suppression of the light structures connected to the boundaries of the mammalian embryo in the plurality of digital images.
   24. The method for predicting a pregnancy outcome in a mammalian embryo, according to embodiment 22, further comprising:
utilizing a deep neural network segmenter trained on the segmented, cropped, and isolated plurality of digital images of mammalian embryos selected from the group consisting of a deep neural network image classification or ridge regression models, with the processor.
   25. The method for predicting a pregnancy outcome in a mammalian embryo, according to embodiment 22, further comprising:
predicting a pregnancy outcome in a mammalian embryo with a methodology selected from a group consisting of a deep neural network segmenter with U-Net, or an autoencoder for extracting features from the plurality of digital images of mammalian embryos.
   26. The method for predicting a pregnancy outcome in a mammalian embryo, according to embodiment 25, further comprising a per frame prediction of pregnancy.
   27. The method for predicting a pregnancy outcome in a mammalian embryo, according to embodiment 25, further comprising a majority voting schema of the per frame prediction of pregnancy.
   28. A method for predicting a pregnancy outcome in a mammalian embryo, which method comprises of:
(a) observing a plurality of mammalian embryos with a microscope;
(b) recording a plurality of digital images of mammalian embryos with a camera that is connected to the microscope; and
(c) utilizing the plurality of digital images of mammalian embryos that are a plurality of both original images and a plurality of mask images with a convolutional neural network that minimizes pixel classification errors that provides semantic representations of the embryos to provide information about embryo qualities with a processor that is electrically connected to the camera to predict pregnancy status of the plurality of mammalian embryos.
   29. The method for predicting a pregnancy outcome in a mammalian embryo, according to embodiment 28, further comprising:
predicting a pregnancy outcome in mammalian embryos with a methodology selected from a group consisting of a deep neural network segmenter with U-Net, an autoencoder for extracting features from the plurality of digital images of mammalian embryos with a random forest classifier, a deep neural network with a VGG16 network with the processor, or a deep neural network utilizing a ResNet structure.
   30. A system for determining mammalian embryo grade and/or stage, which system comprises:
(a) a microscope for observing a plurality of mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are converted from RGB to greyscale, then the boundaries of the mammalian embryos in the plurality of digital images are detected, dilated and expanded, which is then followed by the plurality of digital images of mammalian embryos being segmented, cropped and isolated for utilization in determining embryo grade and/or stage.
   31. The system for determining mammalian embryo grade and/or stage, according to embodiment 30, wherein the boundaries of the mammalian embryos in the plurality of digital images are detected and expanded with a Sobel filter and convolutional process utilizing the processor with the plurality of digital images of mammalian embryos being transformed into a symmetric linear structuring element for dilation.
   32. The system for determining mammalian embryo grade and/or stage, according to embodiment 30, further comprising suppression of light structures connected to the boundaries of the mammalian embryo in the plurality of digital images of mammalian embryos with the processor prior to the plurality of digital images of mammalian embryo being segmented, cropped and isolated.
   33. The system for determining mammalian embryo grade and/or stage, according to embodiment 30, further comprising erosion of the pixels from the boundaries of the mammalian embryos in the plurality of digital images with the processor after the suppression of the light structures connected to the boundaries of the mammalian embryos in the plurality of digital images.
   34. The system for determining mammalian embryo grade and/or stage, according to embodiment 30, further comprising a deep neural network segmenter trained on the segmented, cropped, and isolated plurality of digital images of mammalian embryos for determining mammalian embryo grade and/or stage with a deep neural network image classification with the processor.
   35. The system for determining mammalian embryo grade and/or stage, according to embodiment 30, further comprising a deep neural network segmenter trained on the plurality of segmented, cropped, and isolated digital images of mammalian embryos for determining mammalian embryo pregnancy status with ridge regression models with the deep neural network segmenter's feature maps for determining mammalian embryos grade and/or stage with the processor.
   36. The system for determining mammalian embryo grade and/or stage, according to embodiment 30, wherein the deep neural network segmenter trained on the plurality of segmented, cropped, and isolated digital images of mammalian embryos for determining mammalian embryo grade and/or stage is performed on a U-Net with 512 features and a ridge regression model that utilizes a λ of 2.
   37. The system for determining mammalian embryo grade and/or stage, according to embodiment 30, wherein the deep neural network segmenter trained on the plurality of segmented, cropped, and isolated digital images of mammalian embryos for determining mammalian embryo grade and/or stage is performed using a deep neural network utilizing a ResNet 18 structure.
   38. The system for determining mammalian embryo grade and/or stage, according to embodiment 30, further comprising an autoencoder for extracting features from the plurality of digital images of mammalian embryos for determining mammalian embryo grade and/or stage with the processor.
   39. The system for determining mammalian embryo grade and/or stage, according to embodiment 38, wherein the extracted features are processed with a random forest classifier for determining mammalian embryo grade and/or stage with the processor.
   40. The system for determining mammalian embryo grade and/or stage, according to embodiment 30, further comprising a deep neural network for determining mammalian embryo grade and/or stage.
   41. The system for determining mammalian embryo grade and/or stage, according to embodiment 40, wherein the deep neural network is a VGG16 network.
   42. The system for determining mammalian embryo grade and/or stage, according to embodiment 40, wherein the deep neural network utilizing a ResNet structure.
   43. A system for determining mammalian embryo grade and/or stage, which system comprises:
(a) a microscope for observing mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are a plurality of both original images and a plurality of mask images with a neural network that minimizes pixel classification errors and provides semantic representations of the embryos to provide information about embryo qualities that can determine mammalian embryo grade and/or stage.
   44. The system for determining mammalian embryo grade and/or stage, according to embodiment 43, wherein the neural network includes a trained U-net where 512 features are extracted from the twelfth layer to provide information to determine embryo grade and/or stage.
   45. The system for predicting embryo grade and/or stage outcome in a mammalian embryo, according to embodiment 43, wherein the neural network includes a trained ResNet network model that can predict embryo grade and/or stage.
   46. The system for determining mammalian embryo grade and/or stage, according to embodiment 43, further comprising an autoencoder for extracting features from the plurality of digital images of mammalian embryos for determining mammalian embryo grade and/or stage with the processor.
   47. The system for determining mammalian embryo grade and/or stage, according to embodiment 43, wherein the extracted features are processed with a random forest classifier for determining mammalian embryo grade and/or stage with the processor.
   48 The system for determining mammalian embryo grade and/or stage, according to embodiment 43, further comprises a deep neural network for determining mammalian embryo grade and/or stage with the processor.
   49. The system for determining mammalian embryo grade and/or stage, according to embodiment 48, wherein the deep neural network is a VGG16 network.
   50. The system for predicting embryo grade and/or stage classification in a mammalian embryo, according to embodiment 48, wherein the deep neural network is a ResNet18 structure.
   51. A method for determining mammalian embryo grade and/or stage, which method comprising of:
(a) observing a plurality of mammalian embryos with a microscope;
(b) recording the plurality of digital images of mammalian embryos with a camera connected to the microscope;
(cd) converting the plurality of digital images of mammalian embryos from RGB to greyscale with a processor connected to the camera;
(d) detecting the boundaries of the mammalian embryo in the plurality of digital images with the processor;
(e) dilating the boundaries of the mammalian embryo in the plurality of digital images with the processor;
(f) expanding the boundaries of the mammalian embryo in the plurality of digital images with the processor;
(g) segmenting the plurality of digital images of mammalian embryos with the processor;
(h) cropping the plurality of digital images of mammalian embryos with the processor; and
(i) isolating the plurality of digital images of mammalian embryos with the processor to determine mammalian embryo grade and/or stage.
   52. The method for determining mammalian embryo grade and/or stage, according to embodiment 51, further comprising:
suppressing light structures connected to the boundaries of the mammalian embryo in the plurality of digital images of mammalian embryos with the processor prior to the segmenting, cropping, and isolating the plurality of digital images of mammalian embryos; and eroding pixels from the boundaries of the mammalian embryos in the plurality of digital images with the processor after the suppression of the light structures connected to the boundaries of the mammalian embryo in the plurality of digital images.
   53. The method for determining mammalian embryo grade and/or stage, according to embodiment 51, further comprising:
utilizing a deep neural network segmenter trained on the segmented, cropped, and isolated plurality of digital images of mammalian embryos selected from the group consisting of a deep neural network image classification or ridge regression models with the processor.
   54. The method for determining mammalian embryo grade and/or stage, according to embodiment 51, further comprising:
determining mammalian embryo grade and/or stage with a methodology selected from a group consisting of a deep neural network segmenter with U-Net, an autoencoder for extracting features from the plurality of digital images of mammalian embryos with a random forest classifier, or a deep neural network with a VGG16 network.
   55. The method for determining mammalian embryo grade and/or stage, according to embodiment 51, further comprising a per frame determination of embryo grade and/or stage.
   56. The method for determining mammalian embryo grade and/or stage, according to embodiment 51, further comprising a majority voting schema of the per frame determination of embryo grade and/or stage.
   57. A method for determining mammalian embryo grade and/or stage, which method comprises of:
(a) observing a plurality of mammalian embryos with a microscope;
(b) recording a plurality of digital images of mammalian embryos with a camera that is connected to the microscope; and
(c) utilizing the plurality of digital images of mammalian embryos that are a plurality of both original images and a plurality of mask images with a neural network that minimizes pixel classification errors that provides semantic representations of the embryos to provide information about embryo qualities with a processor that is electrically connected to the camera to determine embryo grade and/or stage of the plurality of mammalian embryos.
   58. The method for determining mammalian embryo grade and/or stage, according to embodiment 57, further comprising:
determining an embryo grade and/or stage in mammalian embryos with a methodology selected from a group consisting of a deep neural network segmenter with U-Net, an autoencoder for extracting features from the plurality of digital images of mammalian embryos with a random forest classifier, a deep neural network with a ResNet structure, or a deep neural network with a VGG16 network.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit the basic operation of the present invention unless otherwise indicated.

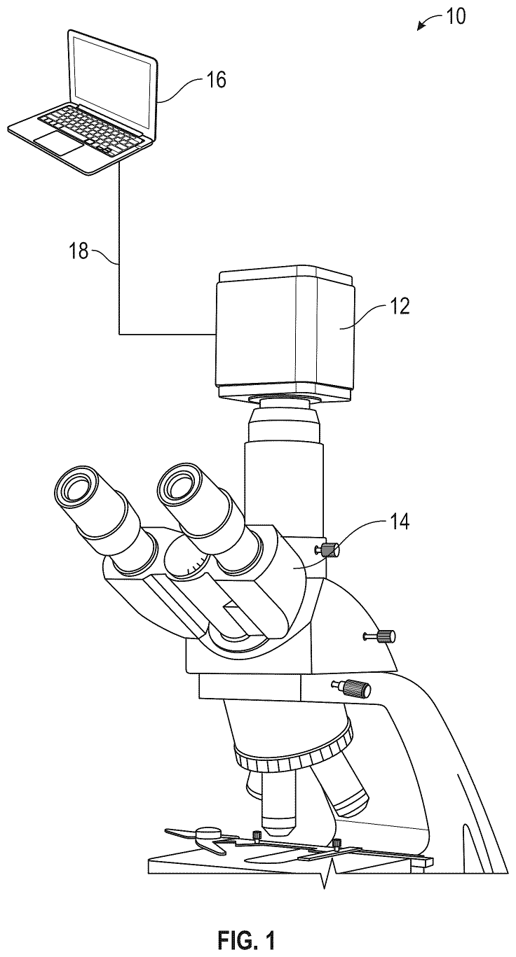

Referring now to FIG. 1, a general system for predicting mammalian embryo viability or determining mammalian embryo grade and stage is generally indicated by the numeral <10>. This system includes a digital video camera <12> mounted to a microscope <14>. In addition, there is an electronic communication cable <18> between the digital video camera <12> and a processor <16>.

A wide range of cameras including digital video cameras <12> can suffice for this application. An illustrative, but nonlimiting, example includes an AmScope® Model IMX178 (color) 1080p 60 fps 5MP HDMI+Wi-Fi Color CMOS C-mount Microscope Camera for Stand-alone and PC Imaging. The sensor optical format is 1/1.9″, the active pixels are 5.04 M (2592×1944), the pixel size is 2.4 μm×2.4 μm, the active sensor area is 6.22 mm×4.67 mm, the shutter is an electronic rolling shutter, the sensitivity is 425 mV @ 1/30s (f/5.6), the spectral response is 380-650 nm with IR-cut filter, the vi deo Preview Resolution (HDMI) is 1920×1080, the video preview framerate (HDMI) is 60 fps, the video capture resolution is 1920×1080, the video capture framerate is 30 fps (SecureDigital), and 25 fps max (Wi-Fi), the internal video capture format is ASF, the photo capture resolution is 2592×1944, the internal photo capture format is JPG, the recording media is SecureDigital card, the conductivity is HDMI, Wi-Fi standard is 802.11n 150 Mbps, and the lens mount is a C-mount. AmScope® is a federally registered trademark of United Scope LLC, having a place of business at 4370 Myford Road, Suite 150, Irvine, California 92606.

A wide range of microscope <14> can suffice for this application. An illustrative, but nonlimiting, example includes an EVIDENT® SZX7 stereomicroscope system. This stereo microscope has a Galilean optical system that provides a quality image, especially when using a digital camera 12. The microscope is suitable for life science imaging applications with high color fidelity optics, a 7:1 zoom ratio, and a universal LED stand. EVIDENT® is a federally registered trademark of the Evident Corporation, having a place of business at 6666 Oaza Inatomi, Tatsuno-machi, Kamiina-gun, Nagano 399-04 Japan.

Any of a wide variety of computers, processors, and controllers can be utilized for the processor 16. An illustrative, but nonlimiting, example includes a laptop. Any of a wide variety of laptops may suffice with an illustrative but nonlimiting example: a DELL® LATTITUDE™ 9520 laptop. DELL® is a federally registered trademark of Dell, Inc. having a place of business at One Dell Way Round Rock, Texas 78682.

The electronic communication cable 18 can be any of a wide variety of electrical cables, e.g., USB 3.0, that can provide high-volume data communication.

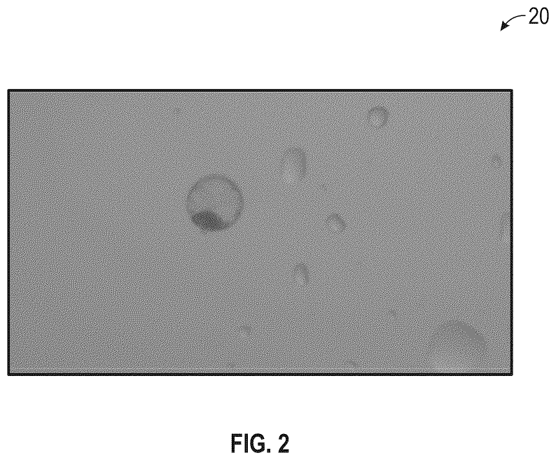

Referring now to FIG. 2, an embryo image collected by the mammalian embryo viability system 10 is generally indicated by the numeral 20.

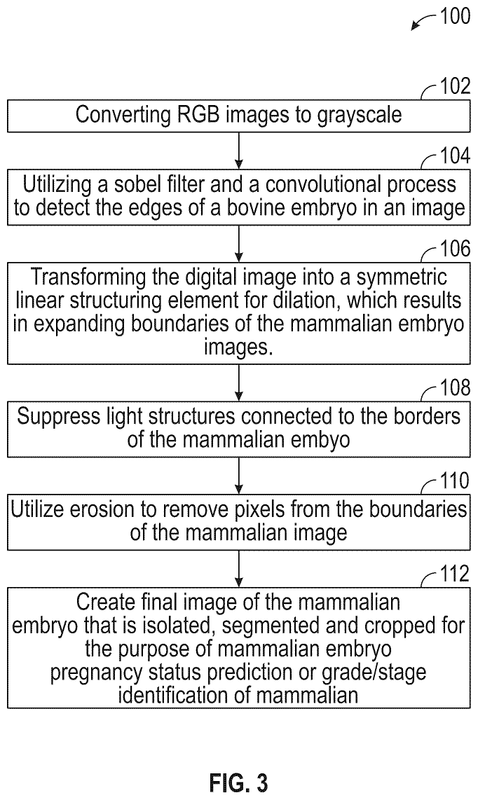

A first image segmentation strategy is the use of image processing techniques to detect the embryo region in the image and perform segmentation with minimal damage to the mammalian embryo area. The software for performing image segmentation will now be discussed with reference to FIG. 3 and is generally indicated by the numeral 100, which depicts a flowchart representative of the computer program instructions executed by the processor 16 shown in FIG. 1. A programmer skilled in the art could utilize this flowchart to program any of a wide variety of electronic controllers/computers in a wide variety of programming languages. Therefore, in the description of the flowcharts in this patent application, the functional explanation marked with numerals in angle brackets, <nnn>, will refer to the flowchart blocks bearing that number.

The first step is to convert RGB images to grayscale <102>. The three primary colors, i.e., red, green, and blue, have values that range from 0-255. Next, the intensity of each color (24 bits) is converted to an approximate grayscale (8 bits). Next, the average pixel values (as previously mentioned that ranges from 0-255) of the primary colors, which are red, green, and blue (popularly referred to as RGB), are combined. Finally, each color band's luminous intensity (24 bits) is integrated into reasonable approximated grayscale values (8 bits). This process reduces computational complexities and simplifies algorithms. In addition, highlights and shadow details provide casier visualization with more of a two-dimensional object than a three-dimensional object. There are a number of equations for grayscale conversion, with a standard equation shown as follows:

Y=0.299R+0.587 G+0.114 B Equation 1

where R, G, and B are integers representing red (R), green (G), and blue (B) with values in the range 0-255.

The next step in the process is to utilize a Sobel filter with a convolutional process to detect the edges of a mammalian embryo in an image <104>. A description of this process can be found in SoCNNet: An Optimized Sobel Filter Based Convolutional Neural Network for SEM Images Classification of Nanomaterials, Progresses in Artificial Intelligence and Neural Systems, 2021, Volume 184 ISBN: 978-981-15-5092-8. Cosimo Ieracitano, Annunziata Paviglianiti, Nadia Mammone, Mario Versaci, Eros Pasero, Francesco Carlo Morabito.

The Sobel filter is used for edge detection and works by calculating the gradient of image intensity at each pixel within the image. It finds the direction of the largest increase from light to dark and the rate of change in that direction. The combination of the Sobel filter and convolutional process is also known as The Canny edge detector, which is an edge detection operator that uses a multi-stage algorithm to detect a wide range of edges in images developed by John F. Canny in 1986.

This edge detection is a technique to extract useful structural information from different mammalian embryo objects and significantly reduce the amount of data to be processed. In addition, this provides detection of the mammalian embryo edge with a low error rate, which means that the detection should accurately catch as many edges shown in the image as possible with the ability to accurately localize on the center of the edge.

A given edge in the image should only be marked once, and where possible, image noise should not create false edges. The calculus of variations is typically described as the sum of four exponential terms, but it can be approximated by the first derivative of a Gaussian function.

There are typically five different steps that include the: applying of the Gaussian filter to smooth the image in order to remove the noise; finding the intensity gradients of the mammalian embryo image; applying gradient magnitude thresholding or lower bound cut-off suppression to remove extraneous elements involved in the mammalian embryo edge detection; apply a double threshold to determine potential mammalian embryo edges; and track mammalian embryo edges by hysteresis: This is completed by suppressing all the other mammalian embryo edges that are weak and not connected to strong edges that are maintained.

The next step is to transform the digital image into a symmetric linear structuring element for dilation, which results in expanding boundaries of the mammalian embryo images. <106>. Dilation adds pixels to the boundaries of objects in an image. The number of pixels added to the objects in an image depends on the size and shape of the structuring element used to process the image. In this case, the mammalian embryo images have the boundaries enhanced. Dilation is a transformation used to resize the mammalian embryo object. Dilation is used to make the mammalian embryo images larger. This transformation produces an image that is the same as the original shape. But there is a difference in the size of the shape.

The next step in the process is to suppress light structures connected to each mammalian image border <108>. There are numerous techniques for performing this function. One well-known technique is J=imclearborder (I) in MATLAB®, which suppresses image I structures that are lighter than their surroundings and connected to the image border. This function can be used to clear the image border. For grayscale images, imclearborder tends to reduce the overall intensity level in addition to suppressing border structures. MATLAB® is a federally registered trademark of Math Works, Inc., having a place of business at 3 Apple Hill Drive, Natick, Massachusetts 01760.

The next step in the process is to utilize erosion to remove pixels from the boundaries of the suppressed light structures connected to each mammalian image border <110>. Erosion removes pixels on object boundaries as well as shrinking the foreground objects. Erosion operates to enlarge foreground holes with the larger size of the mammalian embryo structure. Some advantages of erosion include: removing irrelevant size details from an image; shrinking the image; thinning the image; and stripping way extrusions. The erosion operation usually uses a structuring element for probing and reducing the shapes contained in the input image. Denoting an image by f(x) and the grayscale structuring element by b(x), where B is the space that b(x) is defined, the grayscale erosion involving f by b is given by:

$$( f θ b ) ( x ) = \frac{inf}{y ∈ B} [ f ( x + y ) - b ( y ) ] \qquad Equation 2$$

where “inf” denotes the infimum.

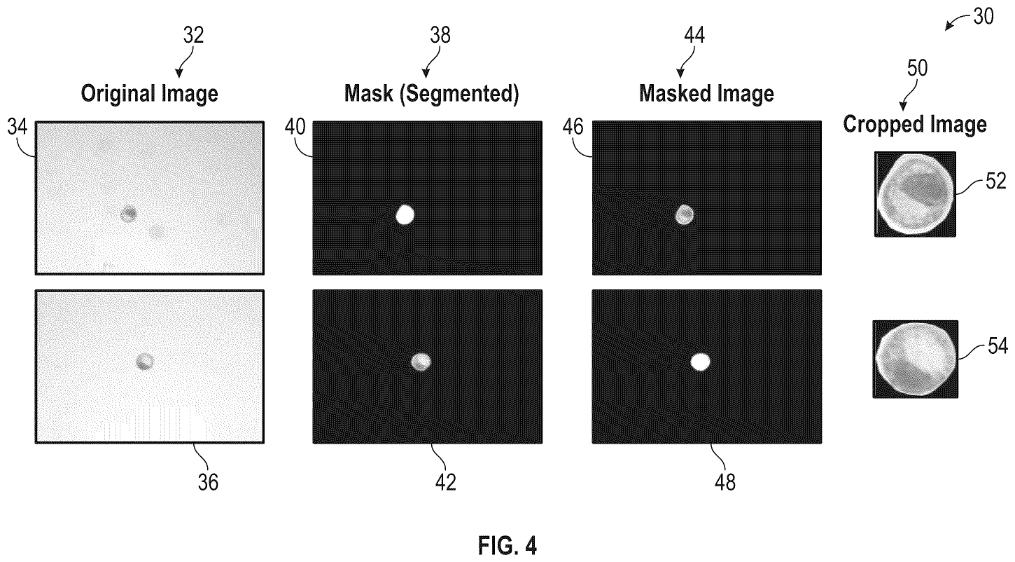

This results in the final image of the mammalian embryo that is isolated, segmented, and cropped for the purpose of mammalian embryo pregnancy status prediction or determining mammalian embryo grade and stage <112>. Illustrative, but nonlimiting, sample results of the flowchart 100 in FIG. 3 are shown in FIG. 4 and are generally indicated by the numeral 30. These examples include two original images 32, including a first original image 34 and a second original image 36. Next, there are two mask-segmented images 38, including the first mask-segmented image 40 and the second mask-segmented image 42. There are then two masked images 44, including the first masked image 46 and the second masked image 48. Finally, the two images are now cropped 50, resulting in the first cropped image 52 and the second cropped image 54, which can be utilized as isolated, segmented, and cropped for the purpose of mammalian embryo pregnancy status prediction or determining mammalian embryo grade and stage.

A second image segmentation strategy is training a deep neural network (DNN) for image segmentation. Although numerous deep neural networks can be utilized, a U-Net convolutional neural network is preferred. “U-Net: Convolutional Networks for Biomedical Image Segmentation”. Imb.informatik.uni-freiburg.de. Retrieved 2018 Dec. 24. B. Wang, L. Wang, J. Chen, Z. Xu, T. Lukasiewicz, and Z. Fu, “W-net: dual supervised medical image segmentation model with multi-dimensional attention and cascade multi-scale convolution,” 2020.

U-Net is a convolutional neural network that was developed for biomedical image segmentation at the Computer Science Department of the University of Freiburg. The network is based on a fully convolutional network, and its architecture was modified and extended to work with fewer training images and to yield more precise segmentations. Segmentation of a 512×512 image takes less than a second on a modern graphics processing unit (“GPU”).

The U-Net architecture is deemed a “fully convolutional network”. The concept is to provide a typical segmentation network that is supplemented by successive layers, where upsampling operators replace pooling operations. Therefore, these layers increase the resolution of the output. A successive convolutional layer can then learn to assemble a precise output based on this information. One significant aspect of the U-Net is that there are a large number of feature channels in the upsampling part, which allow the network to propagate context information to higher resolution layers.

Consequently, the expansive path is more or less symmetric to the contracting path and yields a u-shaped architecture. The network only uses the valid portion of each convolution without any fully connected layers. To predict the pixels in the border region of the mammalian embryo image, the missing context is extrapolated by mirroring the input image. This tiling strategy is important to apply the network to large images since the memory would limit the resolution.

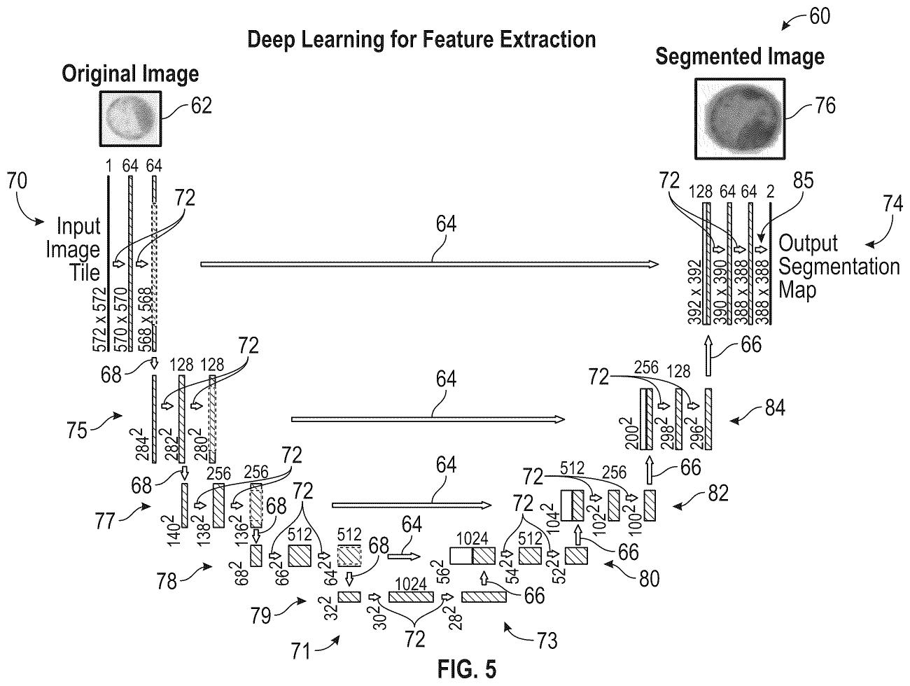

Referring now to FIG. 5, a U-Net is generally indicated by the numeral 60. An original image is shown by the numeral 62. U-Net is an architecture for semantic segmentation. It consists of a contracting path 71 and an expansive path 73. The contracting path 71 follows the typical architecture of a convolutional network. The original image 62 is provided to the input image tile 70. Five levels, 70, 75, 77, and 78, utilize a series of 3×3 kernels. This convolution process is a combination process between two different matrices to produce a new matrix value. After the convolution process, an activation function is added, namely RELU (Rectified Linear Unit). This activation function aims to convert negative values to zero (eliminating negative values in a convoluted matrix). The result of this convolution has about the same size because, during the convolution process, the padding value of zero is used. The second convolution process is to continue the results of the first pooling process with an image matrix input. This second convolution process uses the RELU activation function 72,

There are 2×2 max pooling operation with stride 2 for downsampling 68 between levels 70 and 75, levels 75 and 77, and levels 77 and 78 as well as 79. The term “max pooling” is a pooling operation that calculates the maximum value for patches of a feature map and then utilizes it to generate a downsampled (pooled) feature map. It is usually used after a convolutional layer. It adds a small amount of translation invariance, which means translating an image by a small amount does not significantly affect the values of most pooled outputs. The first convolution process utilizes a 3×3 kernel. This convolution process is a combination process between two different matrices to produce a new matrix value. After the convolution process, an activation function, namely, the RELU (Rectified Linear Unit), is added. This activation function aims to convert negative values to zero (eliminating negative values in a convoluted matrix). The result of this convolution has about the same size because, during the convolution process, the padding value of zero is used. The second convolution process is to continue the results of the first pooling process with an image matrix input. This second convolution process also uses the RELU (Rectified Linear Unit) activation function 72,

In layer 79, there is a series of 3×3 kernels. This convolution process is a combination process between two different matrices to produce a new matrix value. After the convolution process, an activation function is added, namely the RELU (Rectified Linear Unit) function. This activation function aims to convert negative values to zero (eliminating negative values in a convoluted matrix).

Layer 79 provides an upsampling 66 of the feature map followed by a 2×2 convolution (“up-convolution”) that halves the number of feature channels, a concatenation with the correspondingly cropped feature map from the contracting path to level 80 in addition to copied and cropped data 64 from level 78. As stated previously, convolution is a type of matrix operation consisting of a kernel, a small matrix of weights, that slides over input data performing element-impacted multiplication with the part of the input it is on, and then summing the results into an output. Convolution provides weight sharing that reduces the number of effective parameters with an image translation that allows for the same feature to be detected in different parts of the input space. There are three convolution processes 72 utilizing a 3×3 kernel. This convolution process is a combination process between two different matrices to produce a new matrix value. After the convolution process, an activation function is added, namely the RELU (Rectified Linear Unit). This activation function aims to convert negative values to zero (eliminating negative values in a convoluted matrix).

Layer 82 provides an upsampling 66 of the feature map followed by a 2×2 convolution (“up-convolution”) that halves the number of feature channels, a concatenation with the correspondingly cropped feature map from the contracting path to level 84 in addition to copied and cropped data 64 from level 77. As stated previously, convolution is a type of matrix operation consisting of a kernel, a small matrix of weights, that slides over input data performing element-wise multiplication with the part of the input it is on, then summing the results into an output. Convolution provides weight sharing that reduces the number of effective parameters with an image translation that allows for the same feature to be detected in different parts of the input space. There are three convolution processes 72 utilizing a 3×3 kernel. This convolution process is a combination process between two different matrices to produce a new matrix value. After the convolution process, an activation function is added, namely the RELU (Rectified Linear Unit). This activation function aims to convert negative values to zero (eliminating negative values in a convoluted matrix).

Layer 84 provides an upsampling 66 of the feature map followed by a 2×2 convolution (“up-convolution”) that halves the number of feature channels, a concatenation with the correspondingly cropped feature map from the contracting path to level 85 in addition to copied and cropped data 64 from level 75. As stated previously, convolution is a type of matrix operation consisting of a kernel, a small matrix of weights, that slides over input data performing element-wise multiplication with the part of the input it is on, then summing the results into an output. Convolution provides weight sharing that reduces the number of effective parameters with an image translation that allows for the same feature to be detected in different parts of the input space. There are three convolution processes 72 utilizing a 3×3 kernel. This convolution process is a combination process between two different matrices to produce a new matrix value. After the convolution process, an activation function is added, namely the RELU (Rectified Linear Unit). This activation function aims to convert negative values to zero (eliminating negative values in a convoluted matrix).

In layer 85, there are three convolution processes 72 utilizing a 3×3 kernel. This convolution process is a combination process between two different matrices to produce a new matrix value. After the convolution process, an activation function is added, namely the RELU (Rectified Linear Unit). This activation function aims to convert negative values to zero (eliminating negative values in a convoluted and generates an output segmentation map 74 to create segmented mammalian embryo images 76.

Layer 78 is the 12th layer of the trained U-Net and provides 512 features from the 12th layer of the trained U-Net, indicated by numeral 89 in FIG. 5, that are used as predictors of pregnancy status or to determine mammalian embryo grade and stage. These features include the mammalian embryo's shape, quality, and other important aspects that are not easily noticeable by human inspection that provides predictors of pregnancy status or to determine mammalian embryo grade and stage.

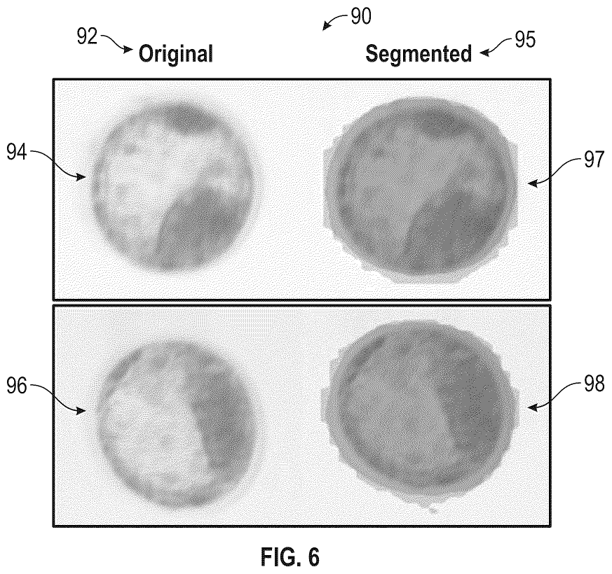

Referring now to FIG. 6, original images and segmented images 90 from the U-Net process shown in FIG. 5. There are original images 92 that include a first image 94 and a second image 96 and segmented images 95 that includes a first image 97 and a second image 98.

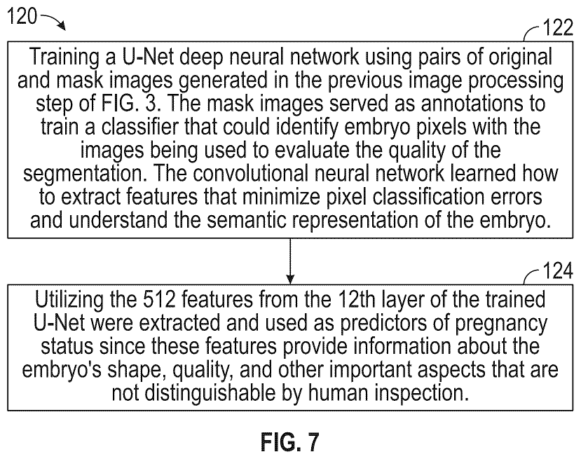

Referring now to FIG. 7, a flow chart is generally shown by the numeral 120. The first step is to train a U-Net deep neural network using pairs of original and mask images generated in the previous image processing step of FIG. 3. The mask images served as annotations to train a classifier that could identify embryo pixels with the images being used to evaluate the quality of the segmentation. The convolutional neural network learned how to extract features that minimize pixel classification errors and understand the semantic representation of the embryo <122>. The second step is to utilize the 512 features from the 12th layer of the trained U-Net that were extracted and used as predictors of pregnancy status or determine mammalian embryo grade and stage since these features provide information about the embryo's shape, quality, and other important aspects that are not easily noticeable by human inspection <124>.

Utilizing either the first or the second image segmentation strategy recited above, the first methodology is to use U-Net features. This involves utilizing 512 features extracted from the trained image segmenter to predict pregnancy status with nonpregnant equaling zero and pregnant equaling one. In addition, mammalian embryo grade and stage can also be determined. A ridge classifier was then employed with the hyperparameter “λ” using 5-fold cross-validation on the training set (with λ values of 0, 0.2, 0.3, 0.6, 0.8, 1, and 2). Based on the cross-validation results, λ=2 was selected for final testing.

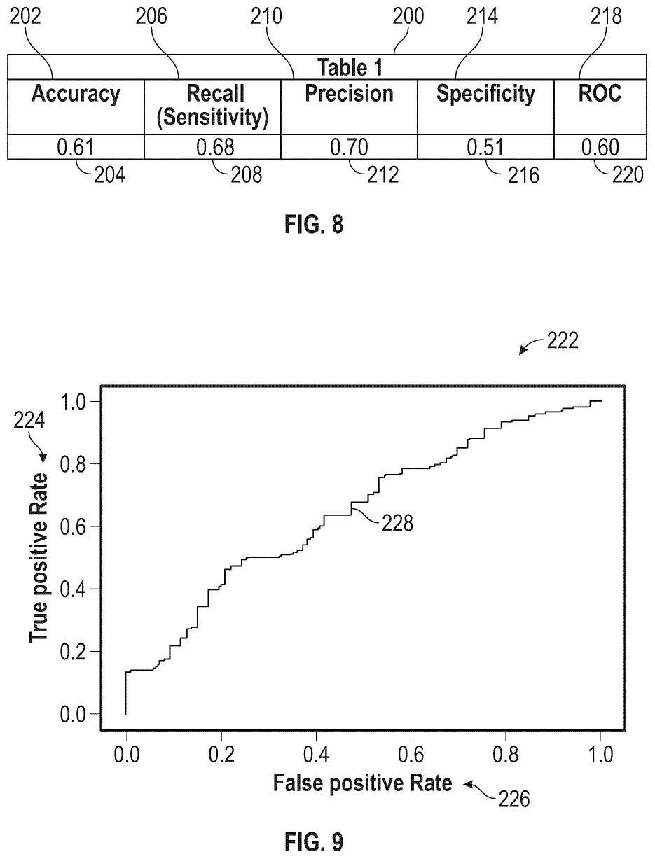

As shown in FIG. 8, Table 1 is generally indicated by the numeral 200; the accuracy 202 tells you how many times this methodology was correct overall, e.g., 0.61, as indicated by the numeral 204. Recall (sensitivity) 206 is how good the methodology is at predicting a specific category, i.e., mammalian embryo pregnancy, e.g., 0.68, as indicated by numeral 208. This methodology can also be used to determine mammalian embryo grade and stage. Precision 210 is how well the model predicts mammalian pregnancy, e.g., 0.70, as indicated by the numeral 212. Finally, specificity 214 is defined as the percentage of true negatives. It is the number of true positives divided by the combination of true positives and false negatives regarding mammalian embryo pregnancy. An example would be 0.51, as indicated by the numeral 216.

The receiver operating characteristic curve, or ROC curve, is a graphical plot that illustrates the diagnostic ability of a binary classifier system as its discrimination threshold is varied. For example, the ROC curve 218 is created by plotting the true positive rate (TPR) against the false positive rate (FPR) at various threshold settings. An example is 0.60, indicated by the numeral 220, with an illustrative example value of 0.60.

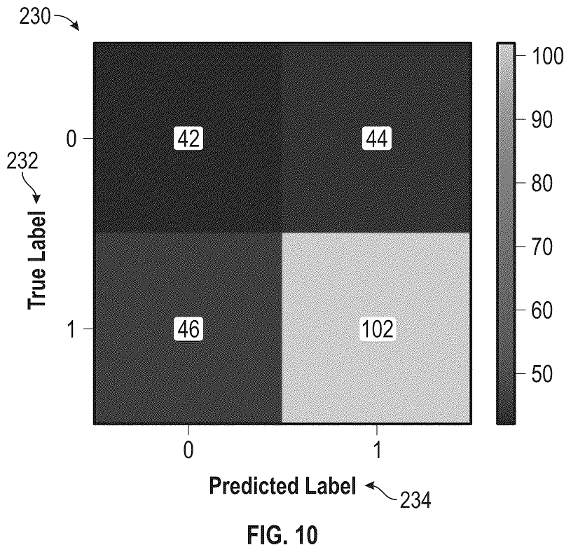

Referring now to FIG. 9, a graph of the ROC curve is generally indicated by the numeral 222 with the true positive data 224 plotted against the false positive data 226, forming the ROC curve 228.

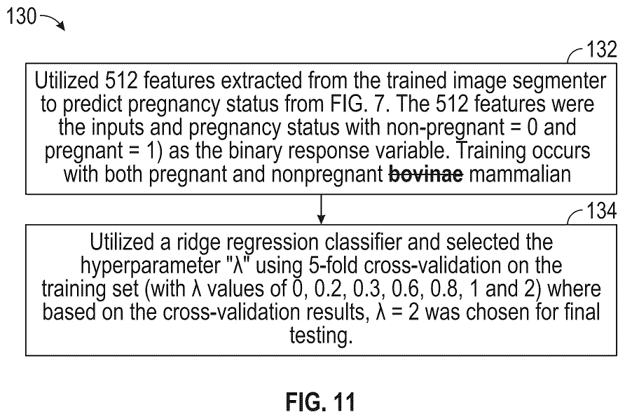

Referring now to FIG. 10, a confusion matrix is generally indicated by numeral 230. Actual values are indicated by the numeral 232, and predicted values by the numeral 234. Zero is indicated as the nonpregnant state, and one is the pregnant state where the predicted and actual pregnant state is 102, the actual nonpregnant state and predicted nonpregnant state is 42, the predicted pregnant state but actually nonpregnant is 44, and the actual predicted nonpregnant state and pregnant state is 46 for a total of 234 samples in this illustrative experiment. This methodology can also be utilized to predict mammalian embryo grade and stage.

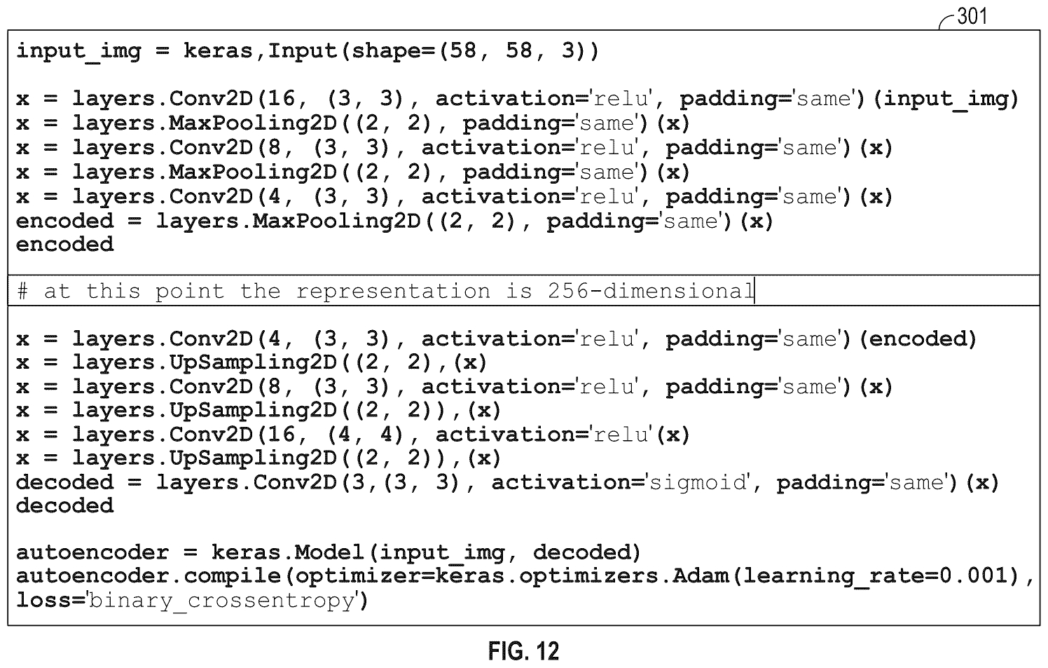

Referring now to FIG. 11, a flow chart is generally shown by the numeral 130. The first step is to utilize 512 features extracted from the trained image segmenter to predict pregnancy status from FIG. 7 using data from the 512 features were the inputs and pregnancy status with nonpregnant=0 and pregnant=1 as the binary response variable. Trained with both pregnant and nonpregnant mammalian embryos <132>. The second step is to utilize a ridge regression classifier and select the hyperparameter “λ” using 5-fold cross-validation on the training set (with λ values of 0, 0.2, 0.3, 0.6, 0.8, 1, and 2) where based on the cross-validation results, λ=2 was chosen for final testing. <134>.

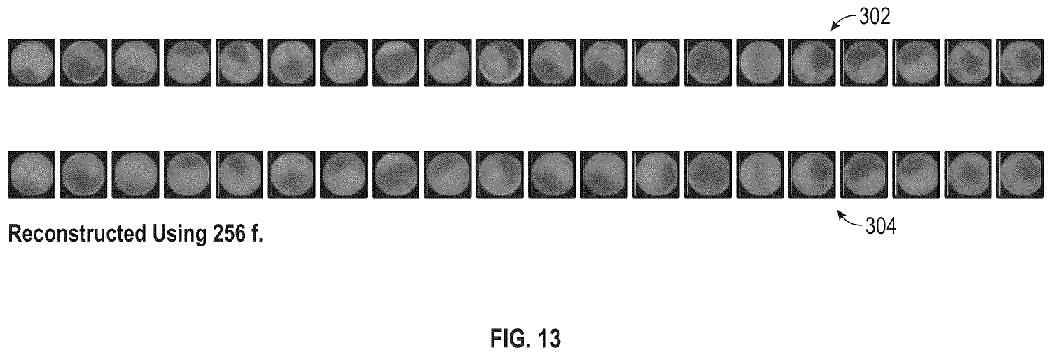

Utilizing either the first or the second image segmentation strategy recited above, a second methodology is to use an autoencoder to extract features of the images. A convolutional neural network with the architecture shown in FIG. 12 is generally identified by the numeral 300 and specifically identified by the numeral 301. The autoencoder is a type of neural network architecture used for unsupervised learning, where the goal is to reconstruct the original input data from a compressed representation, or encoding, learned by the network.

An autoencoder is a type of neural network that can learn to reconstruct images, text, and other data from compressed versions of themselves. Typically, an autoencoder includes three layers including: an encoder; a code; and a decoder.

The encoder layer compresses the input image into a latent space representation. It encodes the input image as a compressed representation in a reduced dimension. The compressed image is a distorted version of the original image. The code layer represents the compressed input fed to the decoder layer. The decoder layer decodes the encoded image back to the original dimension. The decoded image is reconstructed from latent space representation and is a lossy reconstruction of the original image.

When training autoencoders, the most critical hyperparameter to tune the autoencoder are aspects to keep in mind, including the code or bottleneck size. These hyperparameters determine how much data has to be compressed. It can also act as a regularization term. Next, the number of layers is critical when tuning autoencoders. A higher depth increases model complexity, but a lower depth is faster to process. Finally, the number of nodes used per layer is important. The number of nodes decreases with each subsequent layer in the autoencoder as the input to each layer becomes smaller across the layers. Chathurdara Sri Nadith Pathirage, Jun Li, Ling Li, Hong Hao, Wanquan Liu, Pinghe Ni, Structural damage identification based on autoencoder neural networks and deep learning, Engineering Structures, Volume 172, 2018, Pages 13-28, ISSN 0141-0296.

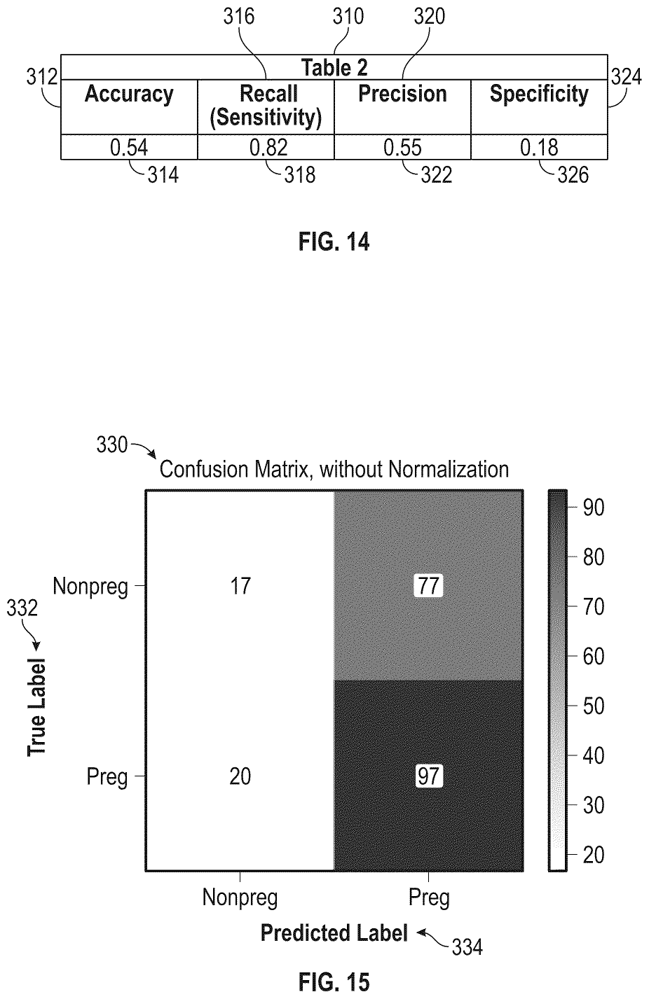

Referring now to FIG. 13, the images used as an input had dimension 58×58 (width and height), and a total of 256 features were extracted in the bottleneck of the autoencoder. Therefore, a few examples of the image reconstruction quality are presented as original images 302 and reconstructed images 304 utilizing the 256 features.

The 256 features were used as inputs in a random forest classifier to predict pregnancy status. This methodology can also be utilized to predict mammalian embryo grade and stage.

In an illustrative but nonlimiting example, a total of 720 images were used in the training set, and 180 images were used in the testing set. The hyperparameters of the network were searched using 5-fold cross-validation in the training set (hyperparameters: bootstrap: [True]; max_depth: [80, 90, 100, 110, 200]; max_features: [‘auto’, ‘sqrt’]; min_samples_leaf: [3, 4, 5]; min_samples_split: [2, 5, 8, 10]; n_estimators: [100, 200, 300].

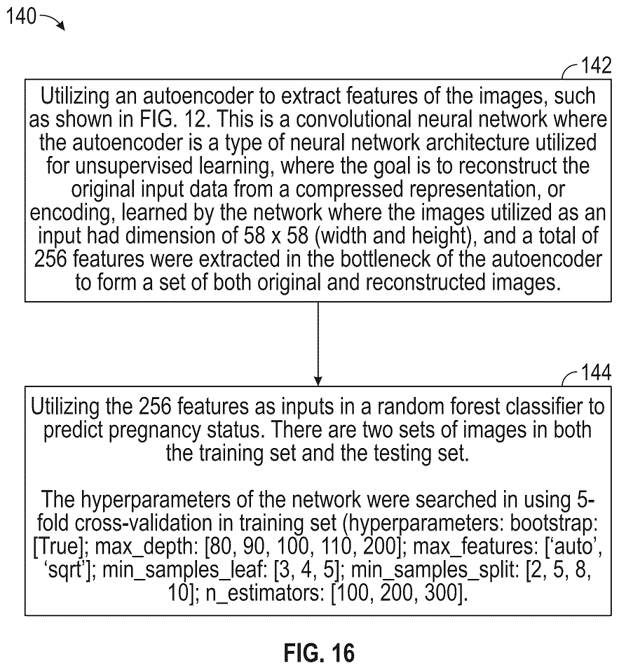

As shown in FIG. 14, Table 2 is generally indicated by the numeral 310. The accuracy 312 tells you how many times this methodology was correct overall, e.g., 0.54, as indicated by the numeral 314. Recall (sensitivity) 316 is how good the methodology is at predicting a specific category, i.e., mammalian embryo pregnancy, e.g., 0.82, as indicated by the numeral 318. Precision 320 is how well the model predicts mammalian pregnancy, e.g., 0.55, as indicated by the numeral 322. Finally, specificity 324 is defined as the percentage of true negatives and is the amount of true positives divided by the combination of true positives and false negatives regarding mammalian embryo pregnancy. An example would be 0.18, as indicated by the numeral 326. This methodology can also be utilized to predict mammalian embryo grade and stage.

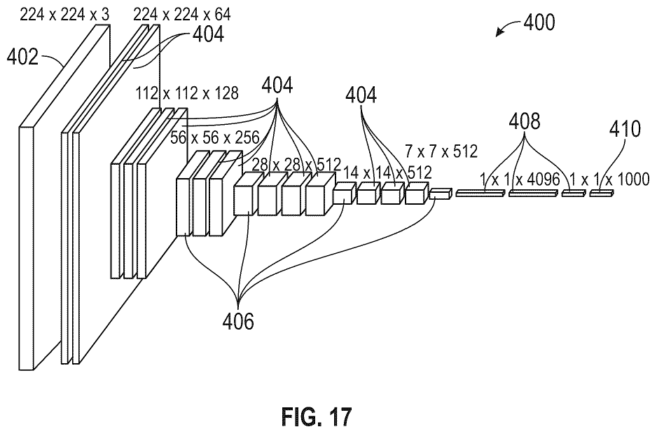

Referring now to FIG. 15, a confusion matrix is generally indicated by numeral 330. Actual or true values are indicated by the numeral 332, and predicted values by the numeral 334. Zero is indicated as the nonpregnant state, and one is the pregnant state. For a total of 211 samples in this illustrative experiment, the combination of the predicted and actual pregnant state is 97, the actual nonpregnant state and predicted nonpregnant state is 17, the predicted pregnant state but is actually nonpregnant is 77, and the actual predicted nonpregnant state and pregnant state is 20.

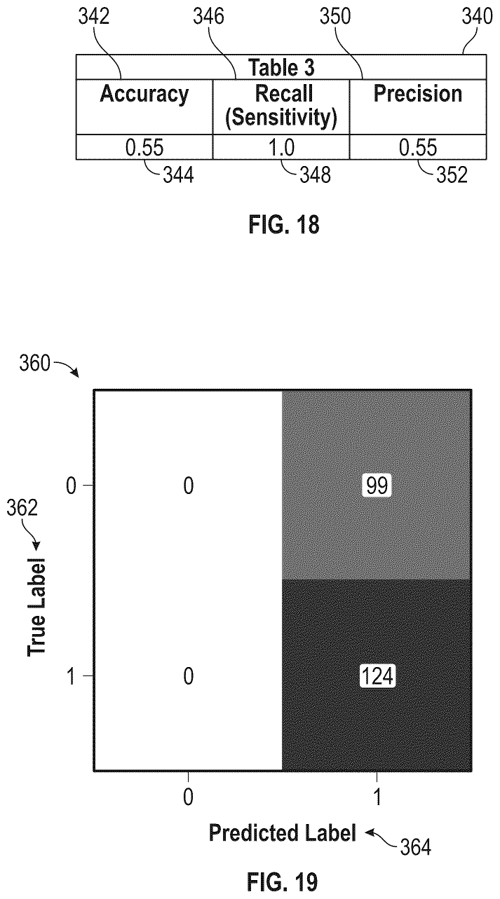

Referring now to FIG. 16, a flow chart is generally shown by the numeral 140. The first step is to utilize an autoencoder to extract the images' features, such as in FIG. 12. This is a convolutional neural network where the autoencoder is a type of neural network architecture utilized for unsupervised learning, where the goal is to reconstruct the original input data from a compressed representation, or encoding, learned by the network where the images utilized as an input had a dimension of 58×58 (width and height), and a total of 256 features were extracted in the bottleneck of the autoencoder to form a set of both original and reconstructed images <142>. The second step is to use 256 features as inputs in a random forest classifier to predict pregnancy status. There are two sets of images in both the training and testing sets. The hyperparameters of the network were searched using 5-fold cross-validation in the training set (hyperparameters: bootstrap: [True]; max_depth: [80, 90, 100, 110, 200]; max_features: [‘auto’, ‘sqrt’]; min_samples_leaf: [3, 4, 5]; min_samples_split: [2, 5, 8, 10]; n_estimators: [100, 200, 300]<144>. This methodology can also be utilized to predict mammalian embryo grade and stage.

Utilizing either the first or the second image segmentation strategy recited above, a third methodology is to utilize a VGG16 deep neural network to extract features of the mammalian embryo images.

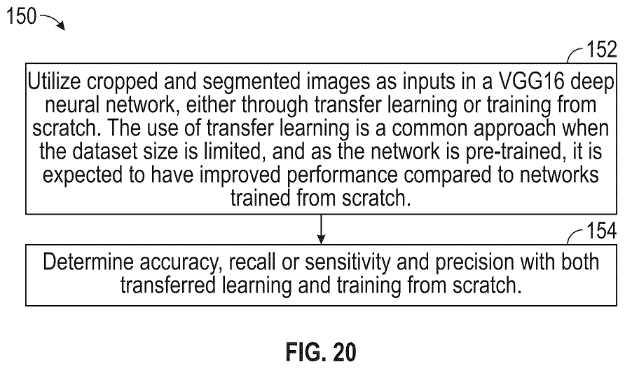

Referring now to FIG. 17, the architecture of the VGG16 system is generally indicated by the numeral 400. First, there is an image 402, which goes through a series of convolution and RELU (Rectified Linear Unit), which is feature extraction performed by the base and consists of three basic operations: Filter an image for a particular feature (convolution), detect that feature within the filtered image RELU (Rectified Linear Unit) and then condense the image to enhance the features (maximum pooling) indicated by numeral 404. Interspersed are several max pooling layers 406, which is a pooling operation that calculates the maximum value for patches of a feature map and uses it to create a downsampled (pooled) feature map. It is usually used after a convolutional layer, which in this case are convolution and RELU (Rectified Linear Unit) layers 404. This is followed by the RELU (Rectified Linear Unit) function in the fully connected layer 408, where RELU (Rectified Linear Unit) and sigmoid algorithms are used. The sigmoid function can transform the input with a finite value from positive to negative to a new value within a range of 0-1. The final output 410 is a conversion to a softmax function. The softmax function is used as the activation function in the output layer of neural network models that predict a multinomial probability distribution. That is, softmax or normalized exponential function converts a vector of K real numbers into a probability distribution of K possible outcomes. It is a generalization of the logistic function to multiple dimensions used in multinomial logistic regression. The softmax function is often used as the last activation function of a neural network to normalize the output of a network to a probability distribution over predicted output classes, based on Luce's choice axiom.

The 16 in VGG16 refers to 16 layers that have weights. In VGG16, there are thirteen convolutional layers, three dense layers, and five max pooling layers, which sum up to twenty-one layers. Still, it has only sixteen weight layers, otherwise known as the learnable parameters layer.

VGG16 takes input tensor size as 224, 244 with 3 RGB channels; with the VGG16 having a large number of hyper-parameters, they focused on having convolution layers of 3×3 filter with stride 1 and always used the same padding and max pool layer of 2×2 filter of stride 2. The convolution and max pool layers are consistently arranged throughout the whole architecture. Conv-1 Layer has 64 filters, Conv-2 has 128 filters, Conv-3 has 256 filters, and both Conv 4 and Conv 5 have 512 filters.

There are three fully connected (FC) layers that follow a stack of convolutional layers: the first two have 4096 channels each, and the third performs 1000-way ILSVRC classification and thereby has 1000 channels (one for each class). The final layer is the soft-max layer.

This approach uses cropped and segmented images as inputs in a VGG16 deep neural network through transfer learning or training from scratch. The use of transfer learning is a common approach when the dataset size is limited, so a pre-trained network makes sense. On the other hand, training from scratch is believed to improve performance but cannot be ascertained from limited experimentation.

J. Tao, Y. Gu, J. Sun, Y. Bic and H. Wang, “Research on vgg16 convolutional neural network feature classification algorithm based on Transfer Learning,” 2021 2nd China International SAR Symposium (CISS), Shanghai, China, 2021, pp. 1-3, doi: 10.23919/CISS51089.2021.9652277. S. Liu and W. Deng, “Very deep convolutional neural network based image classification using small training sample size,” 2015 3rd IAPR Asian Conference on Pattern Recognition (ACPR), Kuala Lumpur, Malaysia, 2015, pp. 730-734, doi: 10.1109/ACPR.2015.748659A9.40

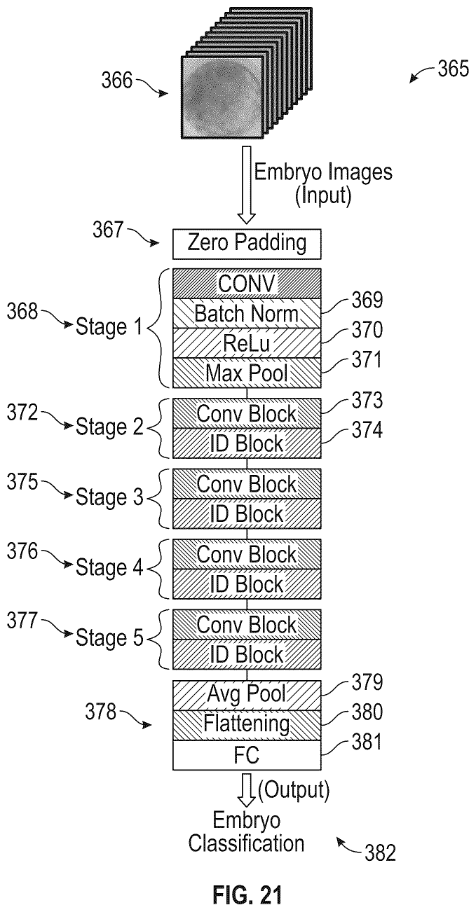

As shown in FIG. 18, Table 3 is generally indicated by the numeral 340. The accuracy 342 tells you how many times this methodology was correct overall, e.g., 0.55, as indicated by the numeral 344. Recall (sensitivity) 346 is how good the methodology is at predicting a specific category, i.e., mammalian embryo pregnancy, e.g., 1.0, as indicated by numeral 348. Precision 350 is how well the model predicts mammalian pregnancy, e.g., 0.55, as indicated by the numeral 352. This methodology can also be utilized to predict mammalian embryo grade and stage.

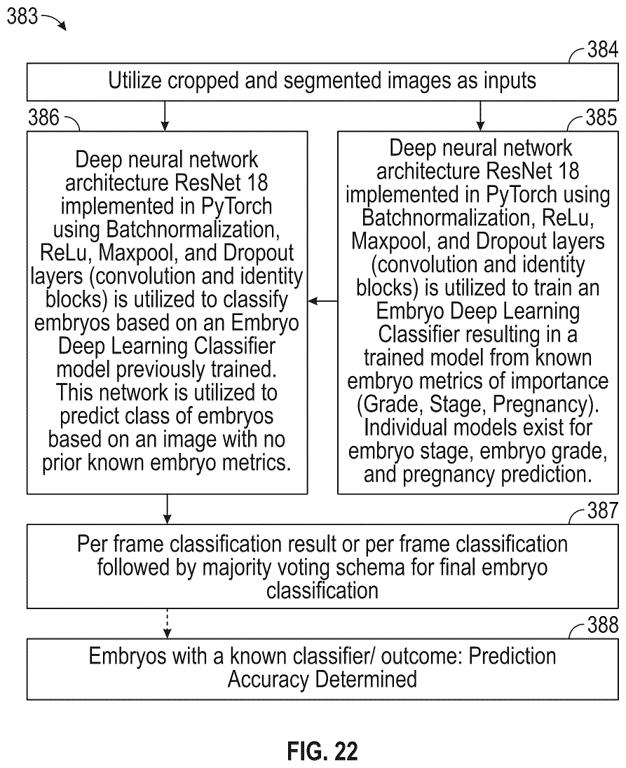

Referring now to FIG. 19, a confusion matrix is generally indicated by numeral 360. Actual or true values are indicated by the numeral 362, and predicted values by the numeral 364. Zero is indicated as the nonpregnant state, and one is the pregnant state. For a total of 223 samples in this illustrative experiment, the combination of the predicted and actual pregnant state is 124, the actual nonpregnant state and predicted nonpregnant state is 0, the predicted pregnant state but is actually nonpregnant is 99, and the actual predicted nonpregnant state and pregnant state is 0. This methodology can also be utilized to predict mammalian embryo grade and stage.

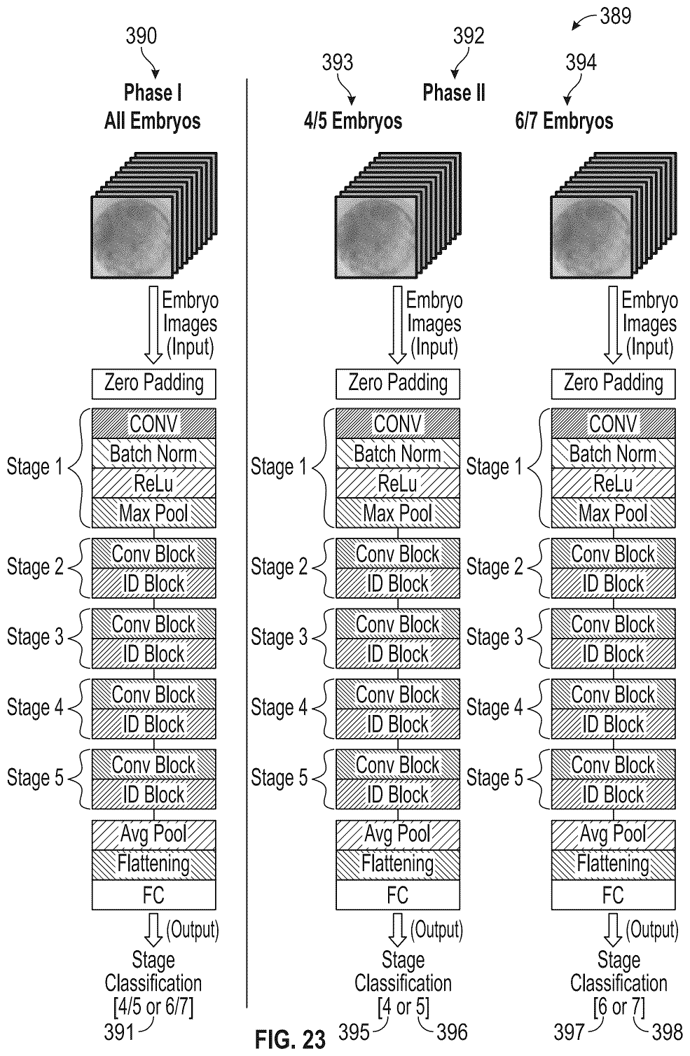

Referring now to FIG. 20, a flow chart is generally shown by the numeral 150. The first step is to utilize cropped and segmented images as inputs in a VGG16 deep neural network through transfer learning or training from scratch. The use of transfer learning is a common approach when the dataset size is limited, and as the network is pre-trained, it is expected to have improved performance compared to networks trained from scratch <152>. The second step is to determine accuracy, recall or sensitivity, and precision with both transferred learning and training from scratch. <154>.

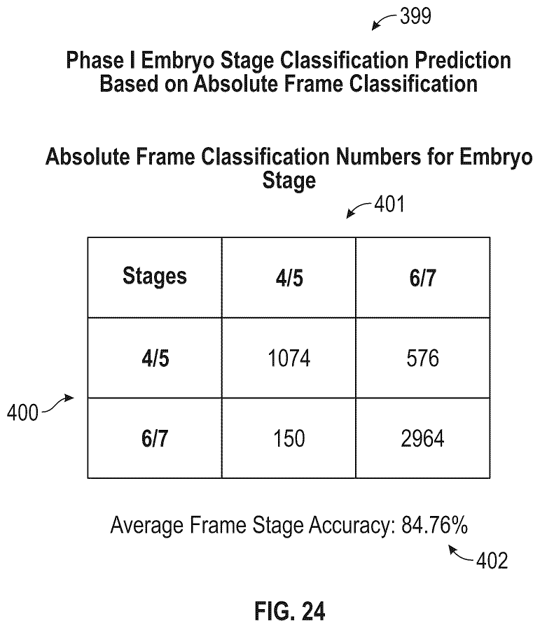

Now refereeing to FIG. 21, the flow chart of ResNet 18 indicated by the numeral 365, which is an 18 layer residual network. ResNet 18 is a deep neural network architecture that can be utilized for classification of images. This schema was utilized to classify embryo grade, stage and pregnancy status. ResNet 18 is first trained using original and mask images that processed as described in FIG. 3 shown by the numeral 366. The padding value of zero is used <367>. Stage 1 <368> consists of a convolution layer including batch normalization, ReLu, and Max pooling. Batch normalization methodology is utilized during the training of artificial neural networks to make them faster and run more efficiently and stable by normalizing the inputs with re-scaling and re-centering <369>. RELU (Rectified Linear Unit) activation function is performed to convert negative values to zero (eliminating negative values in a convoluted matrix) <370>. The last layer of stage 1 is Max pooling <371>, which is a down sampling technique used to reduce input volume by reducing spatial dimensions and removing overlap.

Stage 2 <372> consists of a convolution and identity block, the first convolution block <373> transforms the image and then applies RELU on it. Convolution blocks are utilized to convert the output from a previous block using convolution process operations so that output can be effectively added with the output of another convolution block. The input and output dimensions of a convolution block are different. Convolution provides weight sharing that reduces the number of effective parameters with an image translation that allows for the same feature to be detected in different parts of the input space. Using an example of an image shape of (56×56) with 64 channels, the initial convolution block transforms the image to (28×28) with 128 channels with a 3×3 kernel and 2×2 stride with 1×1 padding, RELU is applied to this transformed output and the output is moved to the Identity block <374>. The input and output are the same dimension in an identify block so no transformation is needed. The process that is utilized in stage 2 is repeated in stage 3, 4 and 5 <375, 376, and 377>.

The final layer contains 3 operations <378>. The first is average pooling <379>, an operation that calculates an average value for each section of a feature map and uses this to develop a down sampled/pooled feature map. Flattening is then applied to the arrays from the pooled feature maps to convert the arrays from 2-Dimensional into a single long continuous linear vector <380>. Numeral 381 (FC) refers to the fully connected layer, where each input node is now connected to each output node with 1000 neurons in which the output is classifications <382>, in this case embryo stage, grade and pregnancy prediction.

K. He, X. Zhang, S. Ren, J. Sun., “Deep Residual Learning for Image Recognition,” 2015 Dec. 10 Computer Vision and Pattern Recognition, doi.org/10.48550/arXiv.1512.03385

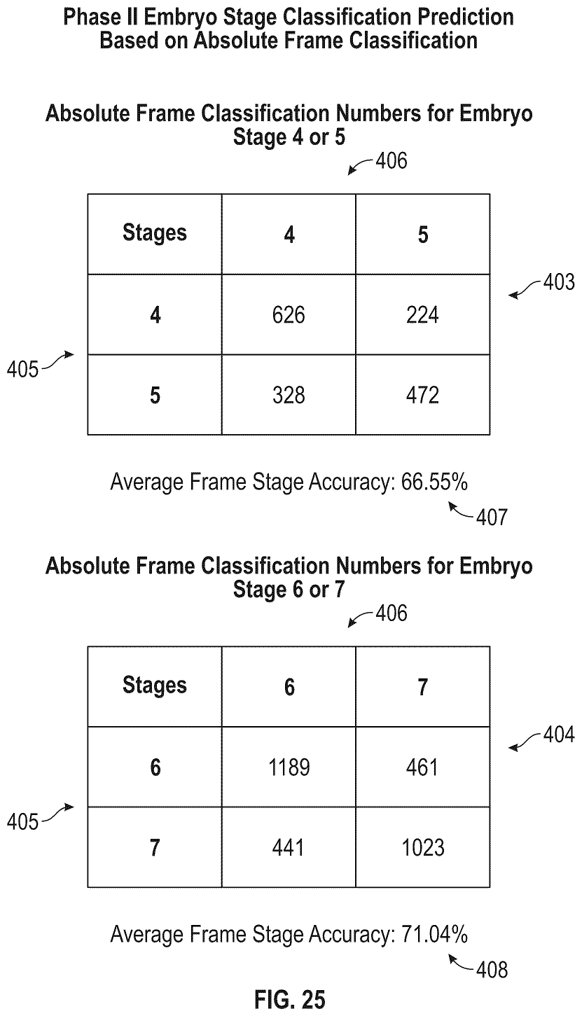

Referring now to FIG. 22, a flowchart is generally shown by the numeral 383 and describes how images flow through the deep learning schema to predict classification of grade, stage and pregnancy. Numeral 384 refers to images that have been cropped and segmented as described in FIGS. 3-5. Numeral 385 describes the process in which the deep learning model is trained in ResNet 18.

A model exists for predicting embryo grade, embryo stage and embryo pregnancy prediction. The ResNet 18 architecture is described in detail in FIG. 21. Numeral 386 describes the process in which the deep learning model takes previously unseen embryo images and predicts a classifier for the embryo for one or all of models (embryo grade, embryo stage, and embryo pregnancy prediction). The ResNet 18 architecture is described in detail in FIG. 21.

The output from ResNet 18 is a predicted classifier, in this case embryo stage, embryo grade or embryo pregnancy prediction. Numeral 387 describes how the next step in the process is to utilize per frame prediction results or majority voting which utilizes the majority vote for a predicted outcome. For example, each embryo may have several images that are fed into the models as input, with each image resulting in an output of predicted classification. Majority voting would predict that embryo classification (grade, stage, or pregnancy prediction) based on the predicted classification majority of that individual embryo's images.

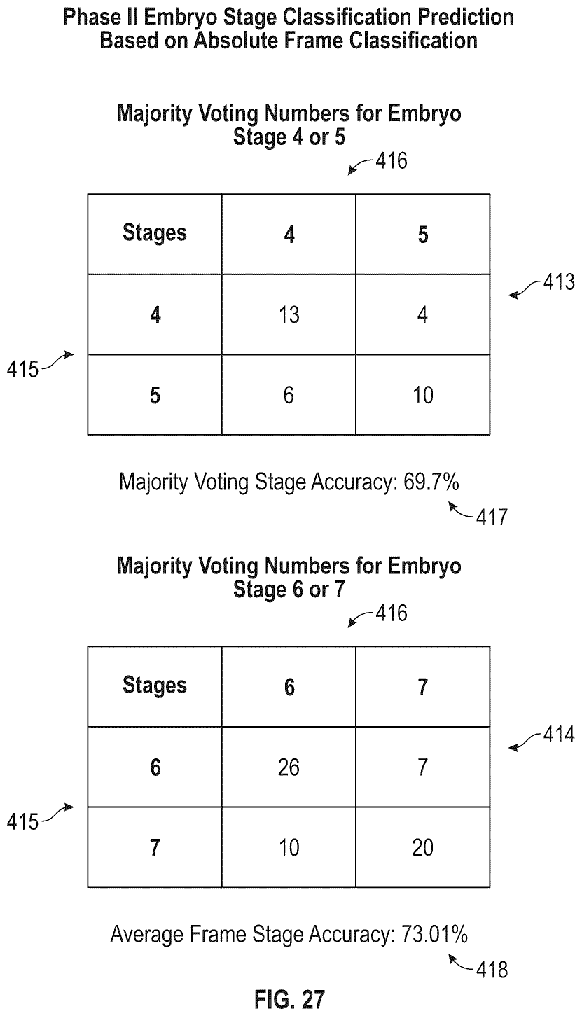

Numeral 388 describes the situation when the embryo classifier is “known”, thus model prediction accuracy of the embryo class in question based on stage, grade and pregnancy prediction can be assessed. These results are in the form on confusion matrices and are described in FIGS. 24-31.

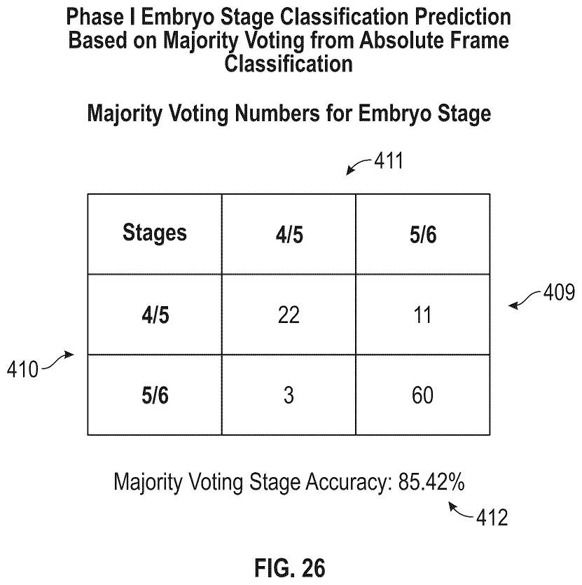

In reference to FIG. 23, a 2 stage process of the ResNet 18 deep learning architecture was utilized for embryo stage prediction and is generally indicated by numeral 389. The

18 architecture and prediction is described in FIG. 21 and FIG. 22. Maximum prediction accuracy for embryo stage was achieved with the 2 phase approach represented in FIG. 23.

Embryos of freezable/transferable quality are assigned a developmental stage or 4, 5, 6 or 7. Stage 4 and 5 embryos are visually more similar to each other than to stage 6 or 7 embryos while stage 6 and 7 embryos are more similar to each other than to stage 4 or 5 embryos. Phase I <390> utilizes embryos of all (unknown) stages as inputs, and results in the binary embryo classification of (stage 4 or 5) or (stage 5 or 6) <391>. Phase I utilizes ResNet 18 architecture as described in FIG. 21 and FIG. 22.

Phase II <392> has a model trained for embryos that are classified as stage 4 or 5 as an output from Phase I <393> and a model trained for embryos that are classified as stage 5 or 6 as an output from Phase I <394>. Phase II utilizes ResNet 18 architecture as described in FIG. 21 and FIG. 22. Output from phase II is an singular stage prediction per image of stage 4 <395>, stage 5 <396>, stage 6 <397> or stage 7 <398>. This 2 phase approach can be utilized for classifications that have more than 2 groups, such as embryo stage or grade.

Now referring FIG. 24, a confusion matrix is generally indicated by numeral 399. Actual or true values are indicated by the numeral 400, and predicted values by the numeral 401. (4/5) means a stage 4 or stage 5 embryo. (6/7) means a stage 6 or stage 7 embryo. This is an illustrative experiment, showing per frame prediction counts from Phase I of the deep learning architecture described in FIG. 22 and FIG. 23 vs actual counts for embryo stage classification. This example illustrates that using per frame classification for embryo stage resulted in a 84.76% accuracy of Phase I <405>, predicting if an embryo frame is either stage 4 or 5, or stage 6 or 7. This methodology can also be utilized to predict mammalian embryo grade or pregnancy prediction.

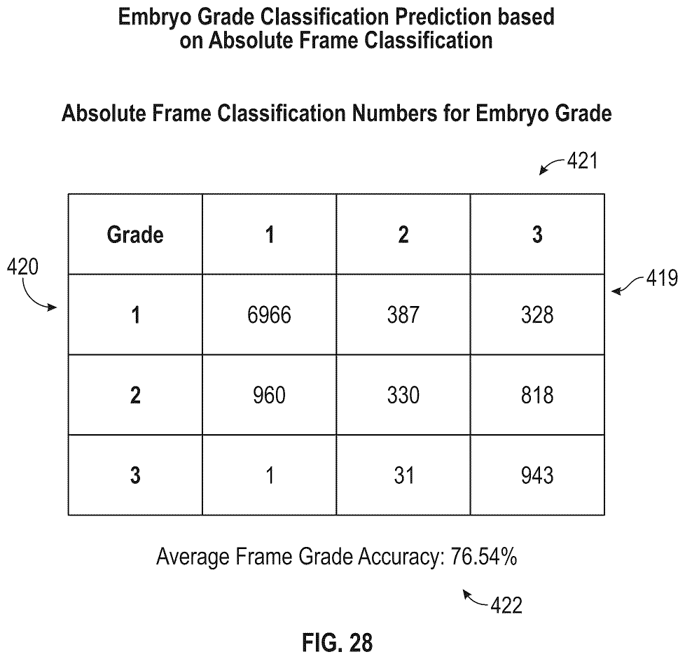

Now referring FIG. 25, a confusion matrix is generally indicated by numeral 403 and in this example is in reference to predicting embryo stage 4 or 5 and in this example is generally indicated by numeral 404 in reference to predicting embryo stage 6 or 7. Actual or true values are indicated by the numeral 405, and predicted values by the numeral 406. This is an illustrative experiment, showing per frame prediction counts from Phase II of the deep learning architecture described in FIG. 22 and FIG. 23 vs actual counts for embryo stage classification. This example illustrates that using per frame classification for embryo stage resulted in a 66.55% accuracy <407> of Phase II predicting stage 4 or 5 embryo and 71.04% accuracy <408> of Phase II predicting stage 6 or 7 embryos. This methodology can also be utilized to predict mammalian embryo grade or pregnancy prediction.

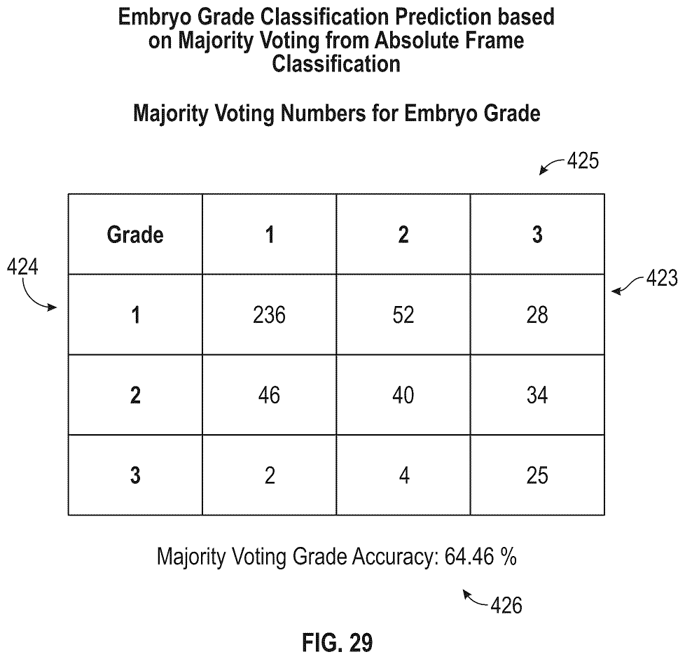

Now refereeing to FIG. 26, a confusion matrix is generally indicated by numeral 409. Actual or true values are indicated by the numeral 410, and predicted values by the numeral 411. (4/5) means a stage 4 or stage 5 embryo. (6/7) means a stage 6 or stage 7 embryo. This is an illustrative experiment, illustrating majority voting classification counts from Phase I of the deep learning architecture described in FIG. 22 and FIG. 23 vs actual embryo stage classification. This example illustrates that using majority voting classification for embryo stage resulted in a 85.42% accuracy of Phase I <412>, predicting if an embryo is either stage 4 or 5, or stage 6 or 7. This methodology can also be utilized to predict mammalian embryo grade or pregnancy prediction.

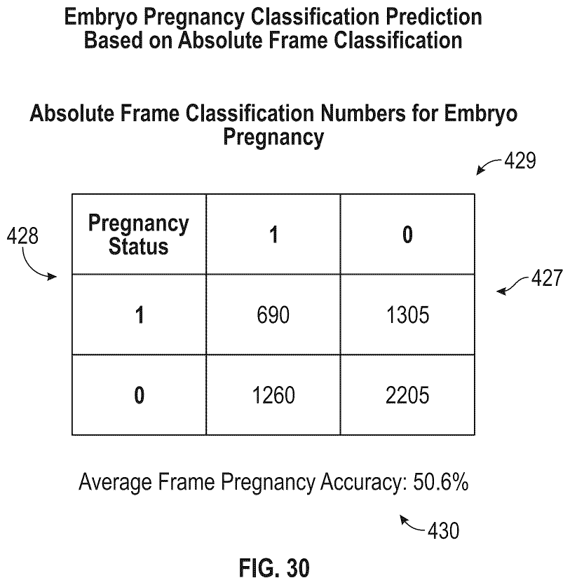

In reference to FIG. 27, a confusion matrix is generally indicated by numeral 413 and in this example is in reference to predicting embryo stage 4 or 5 and in this example is generally indicated by numeral 414 in reference to predicting embryo stage 6 or 7. Actual or true values are indicated by the numeral 415, and predicted values by the numeral 416. This is an illustrative experiment, showing per frame prediction counts from Phase II of the deep learning architecture described in FIG. 22 and FIG. 23 vs actual embryo stage classification. This example illustrates that majority voting classification for embryo stage resulted in a 69.7% accuracy <417> of Phase II predicting stage 4 or 5 embryo and 73.01% accuracy <418> of Phase II predicting stage 6 or 7 embryos. This methodology can also be utilized to predict mammalian embryo grade or pregnancy prediction.

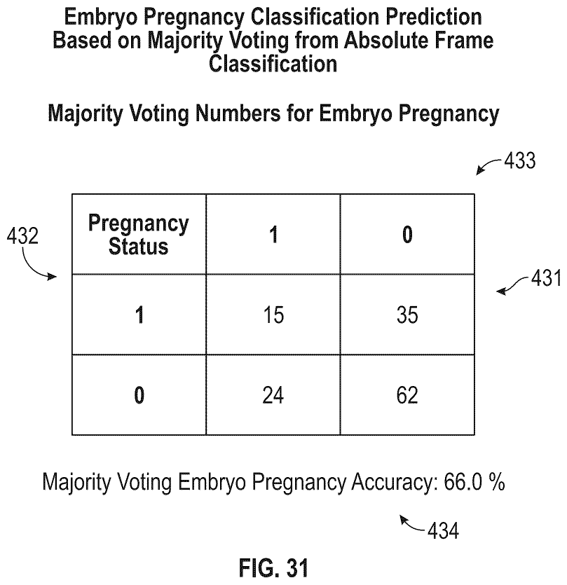

Now in reference to FIG. 28, a confusion matrix is generally indicated by numeral 419. Actual or true values are indicated by the numeral 420, and predicted values by the numeral 421. This is an illustrative experiment, illustrating absolute frame classification counts from the deep learning architecture described in FIG. 21 and FIG. 22 vs actual counts for embryo grade classification. This example illustrates that using absolute frame classification for embryo grade resulted in a 76.54% accuracy <422> of grade prediction (grade 1, 2 or 3). This methodology can also be utilized to predict mammalian embryo stage or pregnancy prediction.

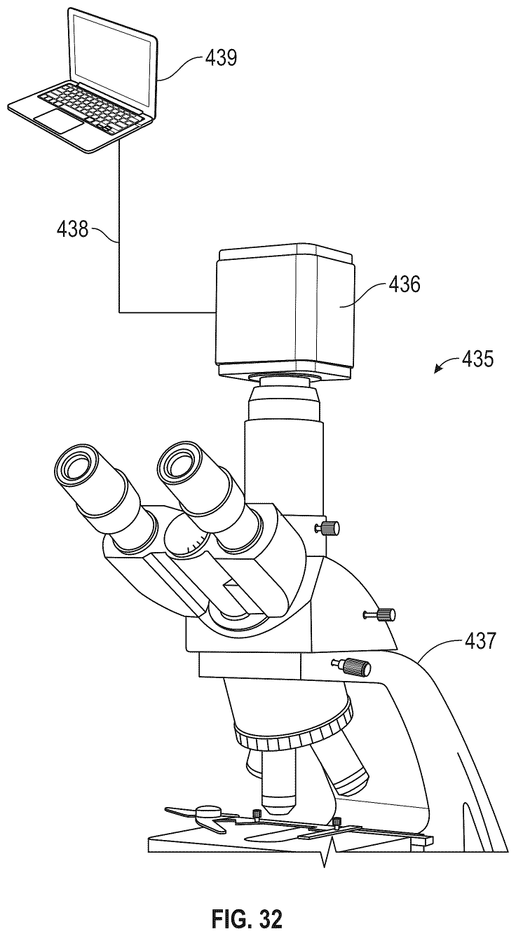

In reference to FIG. 29, a confusion matrix is generally indicated by numeral 423. Actual or true values are indicated by the numeral 424, and predicted values by the numeral 425. This is an illustrative experiment, illustrating majority voting classification from the deep learning architecture described in FIG. 21 and FIG. 22 vs actual embryo grade classification. This example illustrates that using absolute frame classification for embryo grade resulted in a 64.46% accuracy <426> of grade prediction (grade 1, 2 or 3). This methodology can also be utilized to predict mammalian embryo stage or pregnancy prediction.

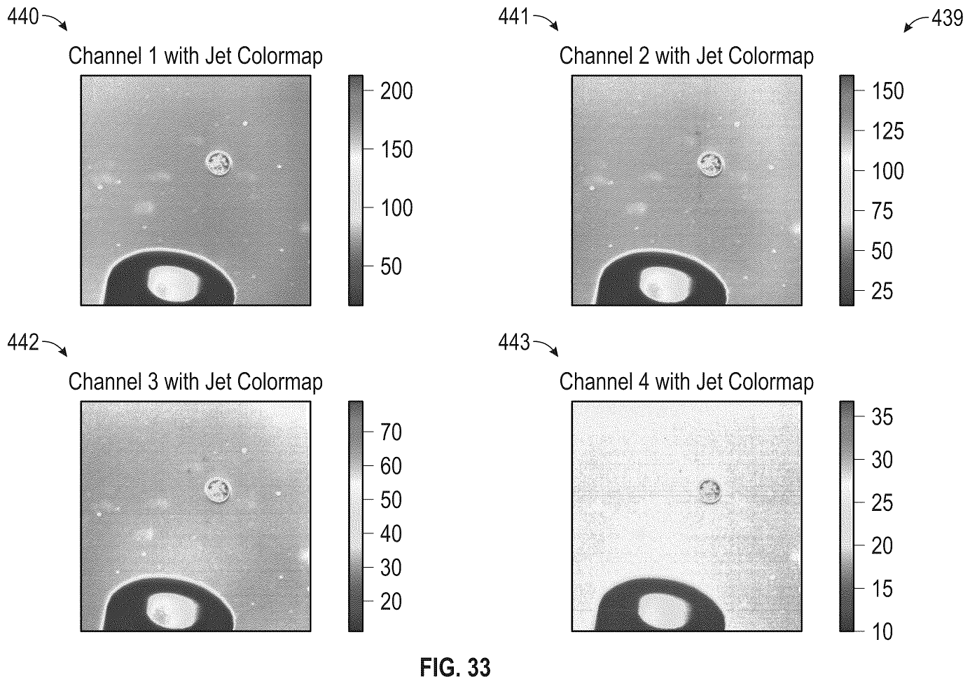

Now in reference to FIG. 30, a confusion matrix is generally indicated by numeral 427. Actual or true values are indicated by the numeral 428, and predicted values by the numeral 429. Zero is indicated as the nonpregnant state, and one is the pregnant state where the predicted and actual pregnant state. This is an illustrative experiment, illustrating absolute frame classification counts from the deep learning architecture described in FIG. 21 and FIG. 22 vs actual counts for embryo pregnancy status. This example illustrates that using absolute frame classification for embryo pregnancy prediction resulted in a 50.6% accuracy <430> of current pregnancy prediction. This methodology can also be utilized to predict mammalian embryo stage or grade prediction.

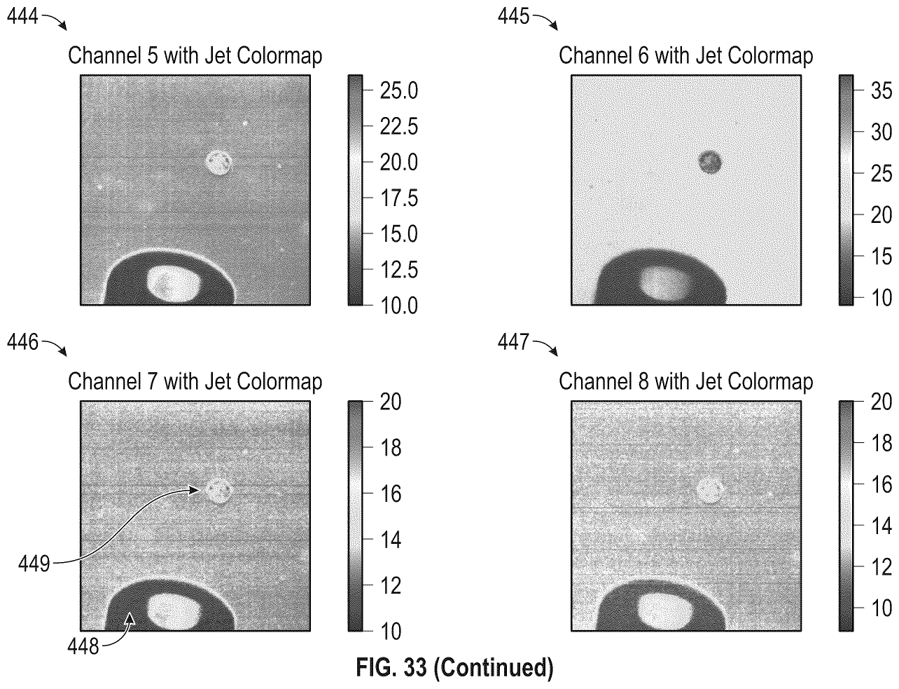

Now in reference to FIG. 31, a confusion matrix is generally indicated by numeral 431. Actual or true values are indicated by the numeral 432, and predicted values by the numeral 433. Zero is indicated as the nonpregnant state, and one is the pregnant state where the predicted and actual pregnant state. This is an illustrative experiment, illustrating majority voting classification counts from the deep learning architecture described in FIG. 21 and FIG. 22 vs actual classification for embryo pregnancy status. This example illustrates that using majority voting classification for embryo pregnancy prediction resulted in a 66.0% accuracy <434> of current pregnancy prediction. This methodology can also be utilized to predict mammalian embryo stage or grade prediction.

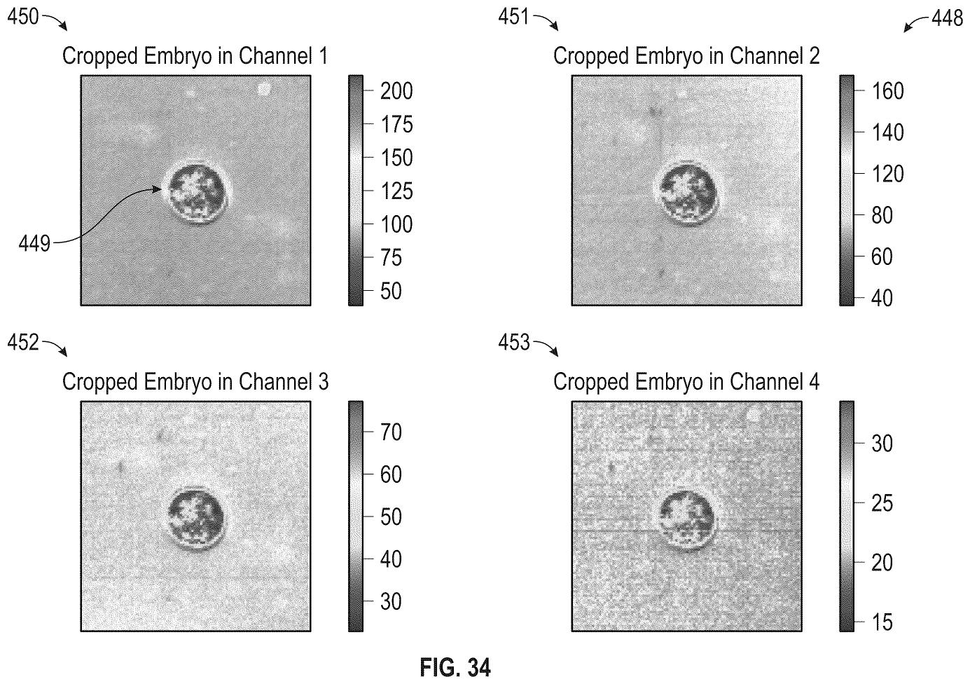

Now refereeing to FIG. 32, an alternative general system for predicting mammalian embryo viability or determining mammalian embryo grade and stage is generally indicated by the numeral 435. This system includes a 8 band NIR hyperspectral video camera <436> mounted to a microscope <437>. In addition, there is an electronic communication cable <438> between the digital video hyperspectral camera <436> and a processor <439>.

A wide range of hyperspectral cameras <436> can suffice for this application. An illustrative, but nonlimiting, example includes the 8 band NIR multispectral camera, MSC2-NIR8-1-A. This camera captures 8 spectral band channels: 720, 760, 800, 840, 860, 900, 940 and 980 nm with the spectral bandwidth (FWHM) of 20 nm. Image pixels per spectral channel are 256×265 (512×512 after debayering) with effective pixel size (H×V) of 16.5 μm×5.5 μm. Frame rate is up to 89 FPS at 8 bits, 45 FPS at 10 bits, and 37 FPS at 12 bits. Video/Image format is 8 bits, 10 bits or 12 bits. ADC bit width is 10 bits/12 bits. Exposure time is 22 μs to 16.77 seconds with a default of 11,116.0 μs. The default digital gain on 0 dB. Black level depends of output: 8 bits at 0 to 15 digits, 10 bits at 0 to 63 digits and 12 bits at 0 to 225 digits. ROI metrics includes: horizontal of 32 to 2,0478 pixels, vertical of 32 to 2,048 lines (Default of 2,048×2,048). The camera includes Anti-X-Talk Technology to enhance and contrast spectral performance. The camera contains a 4MP Global Shutter CMOS Senor (sensor model: AMS CMV4000). The Camera utilizes USB3 Vision and is compatible with M2 and M4 microscope mounting points. This multispectral camera is produced by Spectral Device Inc. and is described on their website spectraldevices.com as of Mar. 28, 2024.

A wide range of microscope <437> can suffice for this application. An illustrative, but nonlimiting, example includes an EVIDENT® SZX7 stercomicroscope system. This stereo microscope has a Galilean optical system that provides a quality image, especially when using a hyperspectral camera <436>. The microscope is suitable for life science imaging applications with high color fidelity optics, a 7:1 zoom ratio, and a universal LED or halogen light stand. EVIDENT® is a federally registered trademark of the Evident Corporation, having a place of business at 6666 Oaza Inatomi, Tatsuno-machi, Kamiina-gun, Nagano 399-04 Japan.

Any of a wide variety of computers, processors, and controllers can be utilized for the processor <439>. An illustrative, but nonlimiting, example includes a laptop. Any of a wide variety of laptops may suffice with an illustrative but nonlimiting example: a DELL® LATTITUDE™ 9520 laptop. DELL® is a federally registered trademark of Dell, Inc. having a place of business at One Dell Way Round Rock, Texas 78682.

The electronic communication cable 438 can be any of a wide variety of electrical cables, e.g., USB 3.0, that can provide high-volume data communication.

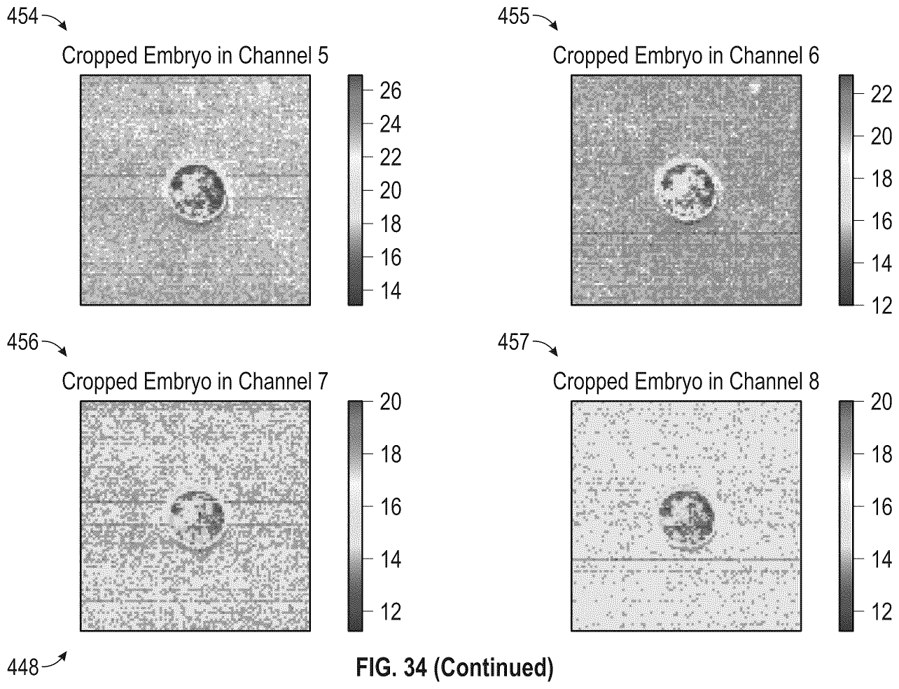

Now referring to FIG. 33, which is an illustrated experiment representing pixel intensity across the 8 bands/channels of the NIR multispectral camera <439>. Each channel is represented individually <440, 441,442, 443, 444, 445, 446, and 447>. In this image example, the pipette tip can be seen in the bottom of each image <448> with the embryo approximately centered in each image <449>. This same orientation is depicted in each image 440-447. Images are initially in TIFF format and contain multiple spectral bands.

The images have 12-bit depth resolution. The images are then reshaped into a uniform size of 256×256 pixels across 8 different spectral channels, accommodating the analysis requirements and ensuring consistency across all images. Spectral data from randomly selected points within the images is plotted. This step involves generating plots that show pixel intensity across different spectral channels, providing insights into the variation in spectral signatures at various points in the images. The spectral channels of the images are visualized individually using the ‘jet’ colormap, aiding in the visual assessment of spectral distribution within the images which is what is shown in FIG. 33. The colormap, which has been converted to greyscale for the purposes of this submission is shown for each individual NIR band and is of the dimension 256×256 and the bands are 720 nm <440>, 760 nm <441>, 800 nm <442>, 840 nm <443>, 860 nm <444>, 900 nm <445>, 940 nm <446> and 980 nm <447>.

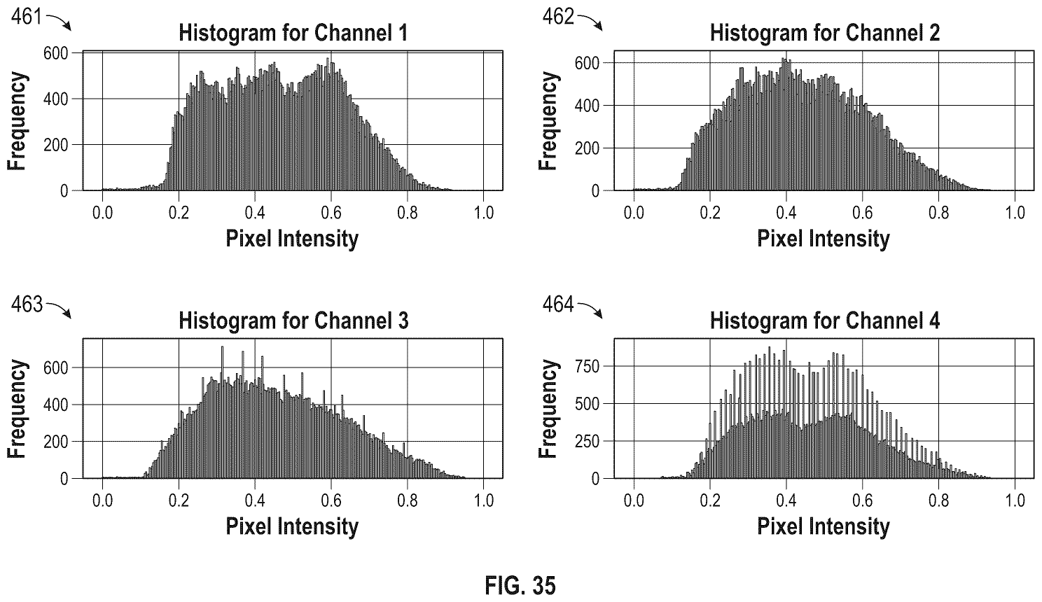

Referring to FIG. 34 <448> which is an illustrated experiment, where the embryo regions are selected and cropped as well as pixel values normalized for each of the 8 bands of the NIR multispectral camera. The embryo is centralized in each band picture <449>. Pixel values across all bands are normalized to a 0-1 range. This process is critical for eliminating the effects of varying illumination and enhancing the comparability of spectral data across different images. The colormap, which has been converted to greyscale for the purposes of this submission is shown for each individual NIR band and is of the dimension 256×256 and the bands are 720 nm <450>, 760 nm <451>, 800 nm <452>, 840 nm <453>, 860 nm <454>, 900 nm <455>, 940 nm <456> and 980 nm <457>.

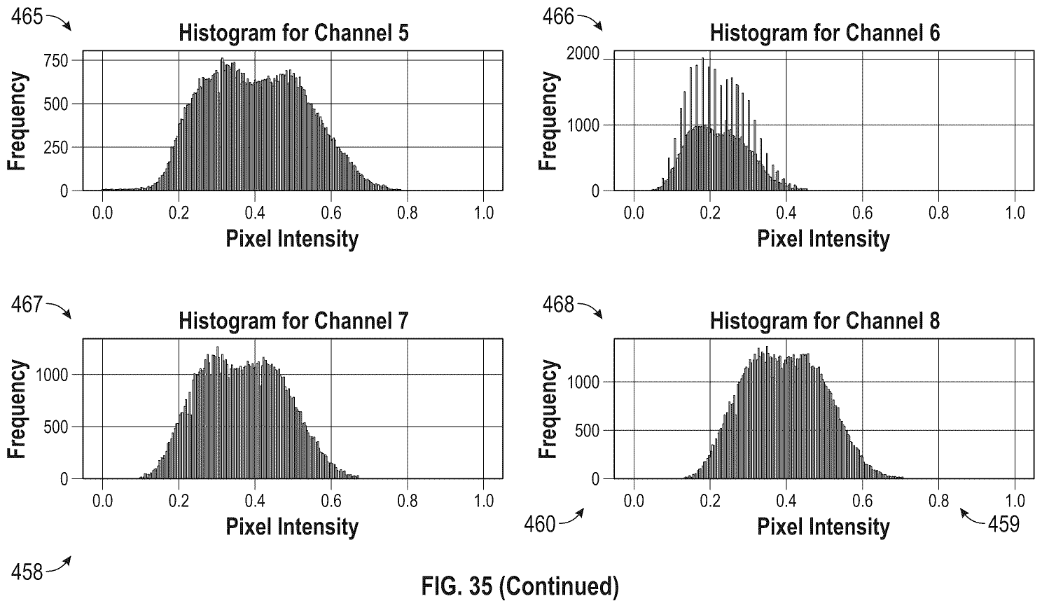

In reference to FIG. 35 which is an illustrative experiment to visually illustrate the distribution of pixel intensities for each of the 8 bands of the NIR multispectral camera <458>.

Histograms are generated for each spectral channel of the normalized images (depicted in FIG. 34), characterizing the distribution of pixel intensities. This analysis aids in understanding the underlying statistical properties of the image data. Normalized pixel intensity is depicted on the x-axis <459> and frequency of that intensity in the image is depicted on the y-axis <460> for each band. Each individual NIR band that was used to develop this histograms are of the dimension 256×256 and the bands are 720 nm <461>, 760 nm <462>, 800 nm <463>, 840 nm <464>, 860 nm <465>, 900 nm <466>, 940 nm <467> and 980 nm <468>.

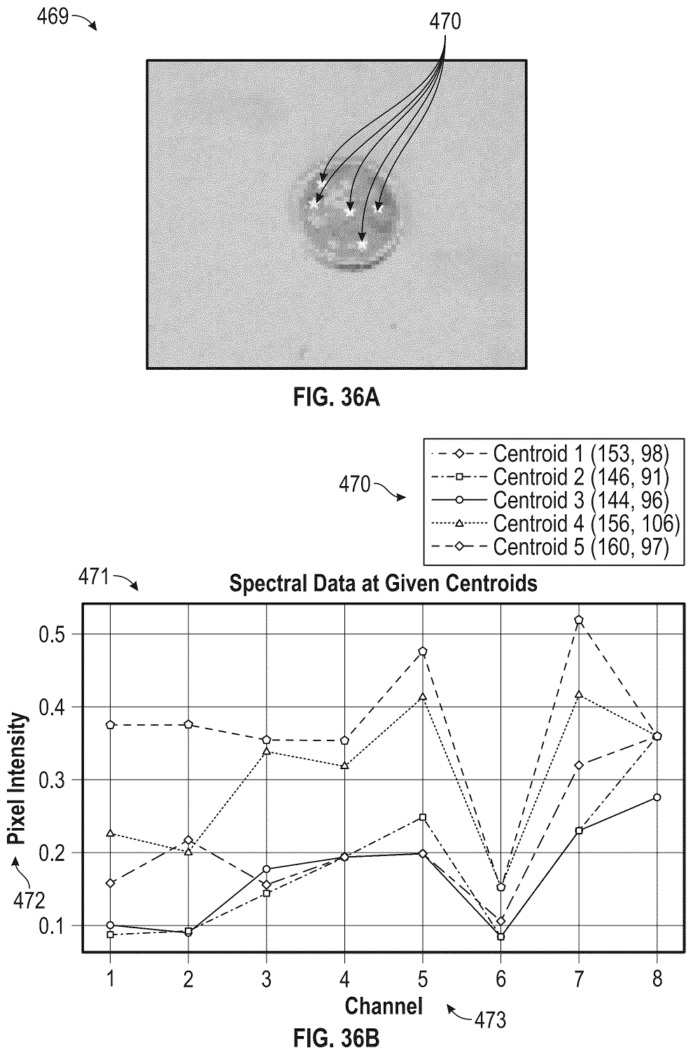

Now refereeing to FIG. 36, generalized by numeral 469. FIG. 36A & FIG. 36B are an illustrative experiment depicting spectral composition for different regions of the embryo for feature extraction from images taken with the 8 band NIR multispectral camera.

Advanced clustering techniques, such as K-means clustering, are applied to the spectral data. This step involves reshaping the images for clustering, standardizing features, and then applying clustering to group pixels or regions with similar spectral characteristics. Clustering is also performed on cropped regions of the images, focusing on specific areas of interest, within the mammalian embryos in the context of this project. The clustered images are visualized to inspect the clustering outcome. Different clusters are represented using varying colors, facilitating the identification of distinct spectral regions within the images. Centroids <470> are defined within the image clusters (within the mammalian embryo in this example) based on the distinct spectral regions and in differing regions with based on similarity/differences of spectral characteristics, which represent specific points of interest within the images. Spectral data is plotted <471> for the predefined centroids <470> based on normalized pixel intensity (y-axis) <472> at each of the 8 bands/channels represented on the x-axis <473>. This analysis provides detailed insight into the spectral signature of selected points, furthering the understanding of the material or biological composition represented in the images and which can be used as selected features in machine learning models.

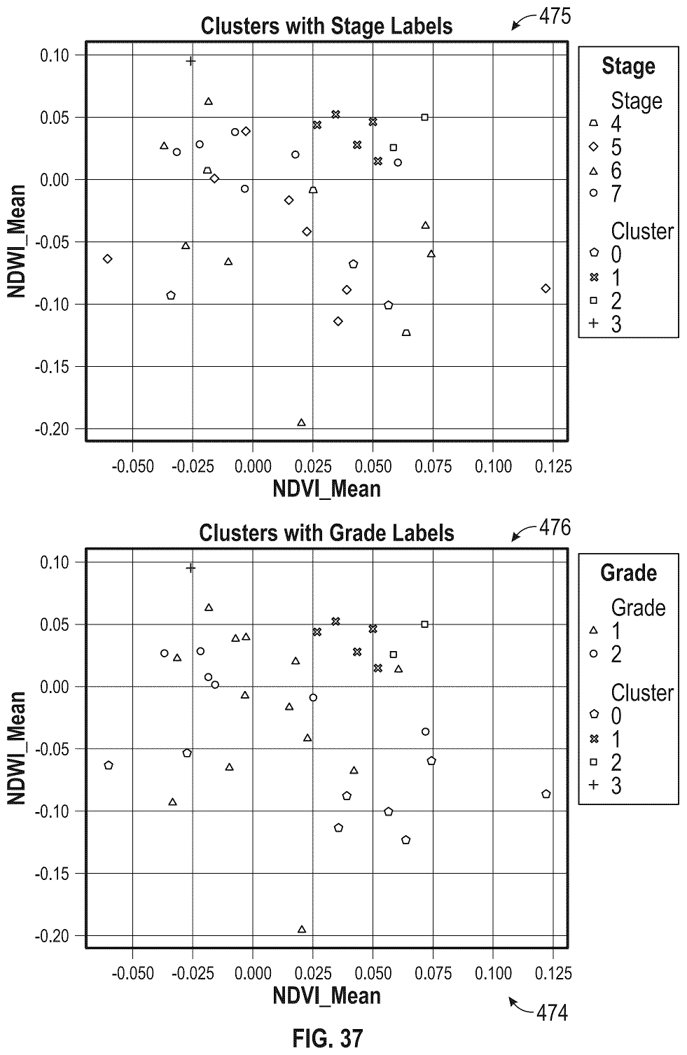

Principal Component Analyses can then be performed to reduce the dimensionality of the spectral data, enabling the visualization of the data in a reduced-dimensional space, and highlighting the intrinsic patterns within the data. An example cluster of embryos based on spectral composition was performed and is represented in FIG. 37<474>. The plot represented by the numeral 475 is depicting embryo stage. Stages 4, 5, 6, and 7 are represented by four colors and four clusters (k-means, k=4). The plot represented by the numeral 476 is depicting embryo grade. Grades 1 and 2 are represented by two colors and four clusters (k-means, k=4).

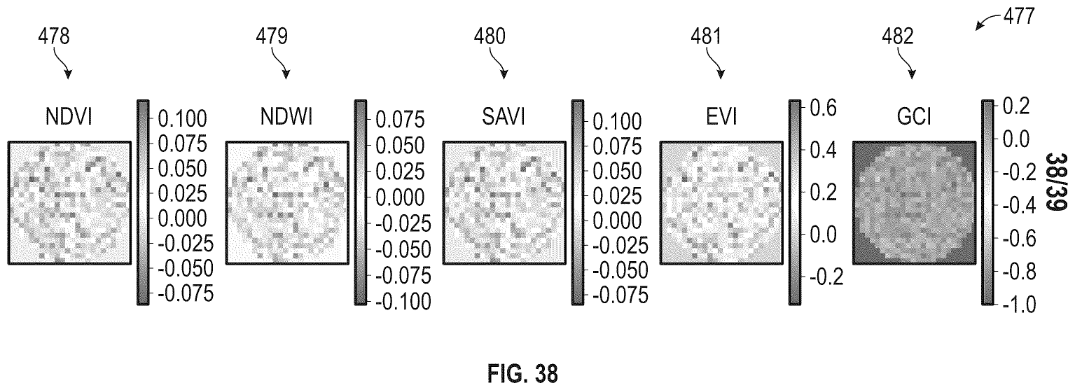

Referring to FIG. 38 which is an illustrative experiment to demonstrate the spectral indices that are computed via machine learning models from the 8 band NIR multispectral images <477> which provide quantitative measures/features that are indicative of specific physical or biological properties.

The spectral indices illustrated in FIG. 38 are illustrative, but nonlimiting, examples: NDVI or normalized difference vegetation index <478>, NDWI or normalized difference water index <479>, SAVI or soil-adjusted vegetation index <480>, EVI or enhanced vegetation index <481>, and GCI or chlorophyll context index <482>. These are examples of spectral image based machine learning indices that are used to extract information related to embryo composition and is not an exhaustive list.

After the image analysis, tabular data containing metadata (embryo info) and derived features (e.g., mean and standard deviation of spectral indices) is analyzed. This analysis involves various machine learning models, including Random Forest classifiers and Multi-Layer Perceptrons (MLPs), which are employed to classify the images or extracted features based on predefined labels, such as stage, grade, or pregnancy outcome in the context of embryo analysis. The models are evaluated using cross-validation techniques, including Leave-One-Out Cross-Validation (LOOCV), to assess their performance accurately. Metrics such as accuracy, F1 score, precision, and recall are calculated to gauge the models' effectiveness. Hyperparameter tuning is performed using GridSearchCV within a nested cross-validation framework, optimizing the machine learning models' parameters to enhance their predictive performance. Clustering based on tabular features, exploring correlations between spectral properties and external labels (e.g., embryo stages, grades or pregnancy status), and mapping original labels to a binary classification system for simplified analysis.

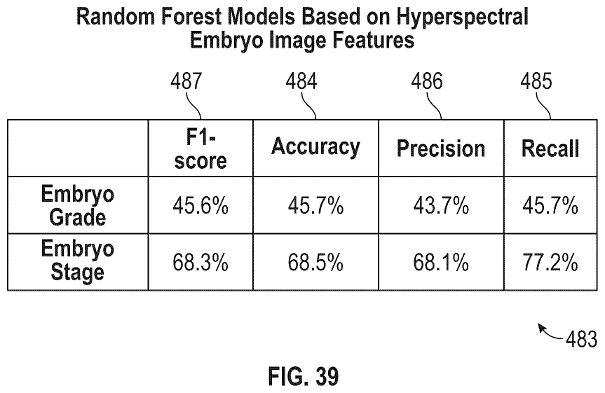

As shown in FIG. 39 in an illustrative example of embryo stage and grade prediction results using random forest machine learning methodology utilizing with features selected from the hyperspectral embryo image data processed as described in FIG. 38 is generally indicated by numeral 483.

The accuracy <484> tells you how many times this methodology was correct overall, Recall (sensitivity) <485> is how good the methodology is at predicting a specific category, i.e., mammalian embryo pregnancy, stage, or grade, Precision <486> is how well the model predicts the classifier in question, in this case mammalian embryo grade and stage. F1-score <487> is the harmonic mean of the precision and recall, where the two metrics contribute equally to the score and function as an indicator of model reliability. This methodology can also be utilized to predict mammalian embryo pregnancy outcome.

The F1-score <487>, accuracy <484>, precision <486>, and recall <485> for grade classification were: 45.6%, 45.7%, 43.7%, 45.7%, respectively. The average accuracy for stage classification for all classes was 34%. Most of embryos of stage 4 were classified as 5, and most of 6 were classified as 7. After grouping 4 and 5 as group 1, and 6 and 7 as group 2, the F1-score, accuracy, precision, and recall were: 68.3%, 68.5%, 68.1%, and 77.2, respectively. These models were based on a small dataset, 35 embryos total, as an example for methodology purposes.

What is claimed is:

1. A system for predicting a pregnancy outcome in a mammalian embryo, which system comprises:
(a) a microscope for observing a plurality of mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are converted from RGB to greyscale, then the boundaries of the mammalian embryos in the plurality of digital images are detected, which is then followed by the plurality of digital images of mammalian embryos being isolated for utilization in pregnancy prediction.

2. The system for predicting a pregnancy outcome in a mammalian embryo, according to claim 1, wherein the boundaries of the mammalian embryos in the plurality of digital images are detected with a Sobel filter and convolutional process utilizing the processor with the plurality of digital images of mammalian embryos being transformed into a symmetric linear structuring element for dilation.

3. The system for predicting a pregnancy outcome in a mammalian embryo, according to claim 1, further comprising suppression of light structures connected to the boundaries of the mammalian embryo in the plurality of digital images of mammalian embryos with the processor prior to the plurality of digital images of mammalian embryo being isolated.

4. The system for predicting a pregnancy outcome in a mammalian embryo, according to claim 3, further comprising erosion of the pixels from the boundaries of the mammalian embryos in the plurality of digital images with the processor after the suppression of the light structures connected to the boundaries of the mammalian embryos in the plurality of digital images.

5. The system for predicting a pregnancy outcome in a mammalian embryo, according to claim 1, further comprising a deep neural network segmenter trained on the isolated plurality of digital images of mammalian embryos for predicting mammalian embryo pregnancy status with a deep neural network image classification with the processor.

6. The system for predicting a pregnancy outcome in a mammalian embryo, according to claim 1, further comprising a deep neural network segmenter trained on the plurality of isolated digital images of mammalian embryos for determining mammalian embryo pregnancy status with ridge regression models with the deep neural network segmenter's feature maps for predicting mammalian embryo pregnancy status with the processor.

7. The system for predicting a pregnancy outcome in a mammalian embryo, according to claim 1, wherein the deep neural network segmenter trained on the plurality isolated digital images of mammalian embryos for determining mammalian embryo pregnancy status is performed on a U-Net with 512 features and a ridge regression model that utilizes a λ of 2.

8. The system for predicting a pregnancy outcome in a mammalian embryo, according to claim 1, wherein the deep neural network segmenter trained on the plurality of isolated digital images of mammalian embryos for determining mammalian embryo pregnancy status is performed using ResNet 18.

9. The system for predicting a pregnancy outcome in a mammalian embryo, according to claim 1, further comprising an autoencoder for extracting features from the plurality of digital images of mammalian embryos for determining mammalian embryo pregnancy status with the processor.

10. The system for predicting a pregnancy outcome in a mammalian embryo, according to claim 9, wherein the extracted features are processed with a random forest classifier for determining mammalian embryo pregnancy status with the processor.

11. The system for predicting a pregnancy outcome in a mammalian embryo, according to claim 1, further comprising a deep neural network for determining mammalian embryo pregnancy status with the processor.

12. The system for predicting a pregnancy outcome in a mammalian embryo, according to claim 11, wherein the deep neural network is a VGG16 network.

13. The system for predicting a pregnancy outcome in a mammalian embryo, according to claim 11, wherein the deep neural network utilizes ResNet 18.

14. A system for predicting pregnancy outcome in a mammalian embryo, which system comprises:
(a) a microscope for observing mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are a plurality of both original images and a plurality of mask images with a neural network that minimizes pixel classification errors and provides semantic representations of the embryos to provide information about embryo qualities that can predict pregnancy status.

15. The system for predicting a pregnancy outcome in a mammalian embryo, according to claim 14, wherein the neural network includes a trained U-net where 512 features are extracted from the twelfth layer to provide information about embryo qualities that can predict pregnancy status.

16. The system for predicting a pregnancy outcome in a mammalian embryo, according to claim 14, wherein the neural network includes a trained ResNet model that can predict a pregnancy status.

17. The system for predicting a pregnancy outcome in a mammalian embryo, according to claim 14, further comprising an autoencoder for extracting features from the plurality of digital images of mammalian embryos for determining mammalian embryo pregnancy status with the processor.

18. The system for predicting a pregnancy outcome in a mammalian embryo, according to claim 17, wherein the extracted features are processed with a random forest classifier for determining mammalian embryo a pregnancy status with the processor.

19. The system for predicting a pregnancy outcome in a mammalian embryo, according to claim 14, further comprising a deep neural network for determining mammalian embryo a pregnancy status with the processor.

20. The system for predicting a pregnancy outcome in a mammalian embryo, according to claim 19, wherein the deep neural network is a VGG16 network.

21. The system for predicting a pregnancy outcome in a mammalian embryo, according to claim 19, wherein the deep neural network is a ResNet18 structure.

22. A method for predicting a pregnancy outcome in a mammalian embryo, which method comprises of:
(a) observing a plurality of mammalian embryos with a microscope;
(b) recording the plurality of digital images of mammalian embryos with a camera connected to the microscope;
(c) converting the plurality of digital images of mammalian embryos from RGB to greyscale with a processor connected to the camera;
(d) detecting the boundaries of the mammalian embryo in the plurality of digital images with the processor;
(e) dilating the boundaries of the mammalian embryo in the plurality of digital images with the processor;
(f) expanding the boundaries of the mammalian embryo in the plurality of digital images with the processor;
(g) segmenting the plurality of digital images of mammalian embryos with the processor;
(h) cropping the plurality of digital images of mammalian embryos with the processor; and
(i) isolating the plurality of digital images of mammalian embryos with the processor.

23. The method for predicting a pregnancy outcome in a mammalian embryo, according to claim 22, further comprising:
(a) suppressing light structures connected to the boundaries of the mammalian embryo in the plurality of digital images of mammalian embryos with the processor prior to the segmenting, cropping, and isolating the plurality of digital images of mammalian embryos; and;
(b) eroding pixels from the boundaries of the mammalian embryos in the plurality of digital images with the processor after the suppression of the light structures connected to the boundaries of the mammalian embryo in the plurality of digital images.

24. The method for predicting a pregnancy outcome in a mammalian embryo, according to claim 22, further comprising:
utilizing a deep neural network segmenter trained on the segmented, cropped, and isolated plurality of digital images of mammalian embryos selected from the group consisting of a deep neural network image classification or ridge regression models, with the processor.

25. The method for predicting a pregnancy outcome in a mammalian embryo, according to claim 22, further comprising:
predicting a pregnancy outcome in a mammalian embryo with a methodology selected from a group consisting of a deep neural network segmenter with U-Net, or an autoencoder for extracting features from the plurality of digital images of mammalian embryos.

26. The method for predicting a pregnancy outcome in a mammalian embryo, according to claim 25, further comprising a per frame prediction of pregnancy.

27. The method for predicting a pregnancy outcome in a mammalian embryo, according to claim 25, further comprising a majority voting schema of the per frame prediction of pregnancy.

28. A method for predicting a pregnancy outcome in a mammalian embryo, which method comprises of:
(a) observing a plurality of mammalian embryos with a microscope;
(b) recording a plurality of digital images of mammalian embryos with a camera that is connected to the microscope; and
(c) utilizing the plurality of digital images of mammalian embryos that are a plurality of both original images and a plurality of mask images with a convolutional neural network that minimizes pixel classification errors that provides semantic representations of the embryos to provide information about embryo qualities with a processor that is electrically connected to the camera to predict pregnancy status of the plurality of mammalian embryos.

29. The method for predicting a pregnancy outcome in a mammalian embryo, according to claim 28, further comprising:
predicting a pregnancy outcome in mammalian embryos with a methodology selected from a group consisting of a deep neural network segmenter with U-Net, an autoencoder for extracting features from the plurality of digital images of mammalian embryos with a random forest classifier, a deep neural network with a VGG16 network with the processor, or a deep neural network utilizing a ResNet structure.

30. A system for determining mammalian embryo grade and/or stage, which system comprises:
(a) a microscope for observing a plurality of mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are converted from RGB to greyscale, then the boundaries of the mammalian embryos in the plurality of digital images are detected, dilated and expanded, which is then followed by the plurality of digital images of mammalian embryos being segmented, cropped and isolated for utilization in determining embryo grade and/or stage.

31. The system for determining mammalian embryo grade and/or stage, according to claim 30, wherein the boundaries of the mammalian embryos in the plurality of digital images are detected and expanded with a Sobel filter and convolutional process utilizing the processor with the plurality of digital images of mammalian embryos being transformed into a symmetric linear structuring element for dilation.

32. The system for determining mammalian embryo grade and/or stage, according to claim 30, further comprising suppression of light structures connected to the boundaries of the mammalian embryo in the plurality of digital images of mammalian embryos with the processor prior to the plurality of digital images of mammalian embryo being segmented, cropped and isolated.

33. The system for determining mammalian embryo grade and/or stage, according to claim 30, further comprising erosion of the pixels from the boundaries of the mammalian embryos in the plurality of digital images with the processor after the suppression of the light structures connected to the boundaries of the mammalian embryos in the plurality of digital images.

34. The system for determining mammalian embryo grade and/or stage, according to claim 30, further comprising a deep neural network segmenter trained on the segmented, cropped, and isolated plurality of digital images of mammalian embryos for determining mammalian embryo grade and/or stage with a deep neural network image classification with the processor.

35. The system for determining mammalian embryo grade and/or stage, according to claim 30, further comprising a deep neural network segmenter trained on the plurality of segmented, cropped, and isolated digital images of mammalian embryos for determining mammalian embryo pregnancy status with ridge regression models with the deep neural network segmenter's feature maps for determining mammalian embryos grade and/or stage with the processor.

36. The system for determining mammalian embryo grade and/or stage, according to claim 30, wherein the deep neural network segmenter trained on the plurality of segmented, cropped, and isolated digital images of mammalian embryos for determining mammalian embryo grade and/or stage is performed on a U-Net with 512 features and a ridge regression model that utilizes a λ of 2.

37. The system for determining mammalian embryo grade and/or stage, according to claim 30, wherein the deep neural network segmenter trained on the plurality of segmented, cropped, and isolated digital images of mammalian embryos for determining mammalian embryo grade and/or stage is performed using a deep neural network utilizing a ResNet 18 structure.

38. The system for determining mammalian embryo grade and/or stage, according to claim 30, further comprising an autoencoder for extracting features from the plurality of digital images of mammalian embryos for determining mammalian embryo grade and/or stage with the processor.

39. The system for determining mammalian embryo grade and/or stage, according to claim 38, wherein the extracted features are processed with a random forest classifier for determining mammalian embryo grade and/or stage with the processor.

40. The system for determining mammalian embryo grade and/or stage, according to claim 30, further comprising a deep neural network for determining mammalian embryo grade and/or stage.

41. The system for determining mammalian embryo grade and/or stage, according to claim 40, wherein the deep neural network is a VGG16 network.

42. The system for determining mammalian embryo grade and/or stage, according to claim 40, wherein the deep neural network utilizing a ResNet structure.

43. A system for determining mammalian embryo grade and/or stage, which system comprises:
(a) a microscope for observing mammalian embryos;
(b) a camera mounted to the microscope for obtaining a plurality of digital images of mammalian embryos; and
(c) a processor electrically connected to the camera for receiving the plurality of digital images of mammalian embryos, wherein the plurality of digital images of mammalian embryos are a plurality of both original images and a plurality of mask images with a neural network that minimizes pixel classification errors and provides semantic representations of the embryos to provide information about embryo qualities that can determine mammalian embryo grade and/or stage.

44. The system for determining mammalian embryo grade and/or stage, according to claim 43, wherein the neural network includes a trained U-net where 512 features are extracted from the twelfth layer to provide information to determine embryo grade and/or stage.

45. The system for predicting embryo grade and/or stage outcome in a mammalian embryo, according to claim 43, wherein the neural network includes a trained ResNet network model that can predict embryo grade and/or stage.

46. The system for determining mammalian embryo grade and/or stage, according to claim 43, further comprising an autoencoder for extracting features from the plurality of digital images of mammalian embryos for determining mammalian embryo grade and/or stage with the processor.

47. The system for determining mammalian embryo grade and/or stage, according to claim 43, wherein the extracted features are processed with a random forest classifier for determining mammalian embryo grade and/or stage with the processor.

48. The system for determining mammalian embryo grade and/or stage, according to claim 43, further comprises a deep neural network for determining mammalian embryo grade and/or stage with the processor.

49. The system for determining mammalian embryo grade and/or stage, according to claim 48, wherein the deep neural network is a VGG16 network.

50. The system for predicting embryo grade and/or stage classification in a mammalian embryo, according to claim 48, wherein the deep neural network is a ResNet18 structure.

51. A method for determining mammalian embryo grade and/or stage, which method comprising of:
(a) observing a plurality of mammalian embryos with a microscope;
(b) recording the plurality of digital images of mammalian embryos with a camera connected to the microscope;
(cd) converting the plurality of digital images of mammalian embryos from RGB to greyscale with a processor connected to the camera;
(d) detecting the boundaries of the mammalian embryo in the plurality of digital images with the processor;
(e) dilating the boundaries of the mammalian embryo in the plurality of digital images with the processor;
(f) expanding the boundaries of the mammalian embryo in the plurality of digital images with the processor;
(g) segmenting the plurality of digital images of mammalian embryos with the processor;
(h) cropping the plurality of digital images of mammalian embryos with the processor; and
(i) isolating the plurality of digital images of mammalian embryos with the processor to determine mammalian embryo grade and/or stage.

52. The method for determining mammalian embryo grade and/or stage, according to claim 51, further comprising:
suppressing light structures connected to the boundaries of the mammalian embryo in the plurality of digital images of mammalian embryos with the processor prior to the segmenting, cropping, and isolating the plurality of digital images of mammalian embryos; and
eroding pixels from the boundaries of the mammalian embryos in the plurality of digital images with the processor after the suppression of the light structures connected to the boundaries of the mammalian embryo in the plurality of digital images.

53. The method for determining mammalian embryo grade and/or stage, according to claim 51, further comprising:
utilizing a deep neural network segmenter trained on the segmented, cropped, and isolated plurality of digital images of mammalian embryos selected from the group consisting of a deep neural network image classification or ridge regression models with the processor.

54. The method for determining mammalian embryo grade and/or stage, according to claim 51, further comprising:
determining mammalian embryo grade and/or stage with a methodology selected from a group consisting of a deep neural network segmenter with U-Net, an autoencoder for extracting features from the plurality of digital images of mammalian embryos with a random forest classifier, or a deep neural network with a VGG16 network.

55. The method for determining mammalian embryo grade and/or stage, according to claim 51, further comprising a per frame determination of embryo grade and/or stage.

56. The method for determining mammalian embryo grade and/or stage, according to claim 51, further comprising a majority voting schema of the per frame determination of embryo grade and/or stage.

57. A method for determining mammalian embryo grade and/or stage, which method comprises of:
(a) observing a plurality of mammalian embryos with a microscope;
(b) recording a plurality of digital images of mammalian embryos with a camera that is connected to the microscope; and
(c) utilizing the plurality of digital images of mammalian embryos that are a plurality of both original images and a plurality of mask images with a neural network that minimizes pixel classification errors that provides semantic representations of the embryos to provide information about embryo qualities with a processor that is electrically connected to the camera to determine embryo grade and/or stage of the plurality of mammalian embryos.

58. The method for determining mammalian embryo grade and/or stage, according to claim 57, further comprising:
determining an embryo grade and/or stage in mammalian embryos with a methodology selected from a group consisting of a deep neural network segmenter with U-Net, an autoencoder for extracting features from the plurality of digital images of mammalian embryos with a random forest classifier, a deep neural network with a ResNet structure, or a deep neural network with a VGG16 network.
